(19) United States
(12) Patent Application Publication
(10) Pub. No.: US 2017/0115446 A1
(43) Pub. Date: Apr. 27, 2017

(54) LIGHTING DEVICE AND DISPLAY DEVICE

(71) Applicant: Sharp Kabushiki Kaisha, Sakai City, Osaka (JP)

(72) Inventors: Yoshinobu HIRAYAMA, Sakai City (JP); Shugo YAGI, Yonago-shi (JP); Toru INATA, Yonago-shi (JP)

(21) Appl. No.: 15/127,043

(22) PCT Filed: Feb. 19, 2015
(86) PCT No.: PCT/JP2015/054555

§ 371 Date: Sep. 19, 2016

(30) Foreign Application Priority Data
Mar. 20, 2014 (JP) 2014-058160

(51) Int. Cl. F21V 8/00

(52) U.S. Cl. CPC G02B 6/0053; G02B 6/0056; G02B 6/0073; G02B 6/0038

(57) ABSTRACT

A lighting device includes a light source, a light guide plate including a light incident surface, a non-light input opposite surface, and a light emission surface, a prism sheet including a base member, a light input-side prism portion formed on a light input-side plate surface of the base member and including light input-side unit prisms, and a light output-side prism portion formed on a light output-side plate surface of the base member and including light output-side unit prisms, and an incidence angle control structure in which a first light output-side inclined surface, a first light input-side inclined surface, and a second light input-side inclined surface respectively make inclination angles with respect to the plate surface of the base member, having a magnitude such that a light incidence angle with respect to the first light output-side inclined surface is in an angle range including the Brewster's angle.

### TECHNICAL FIELD

The present invention relates to a lighting device and a display device.

### BACKGROUND ART

In recent years, display elements of image display devices, such as television receivers, have been shifting from the conventional cathode-ray tube to thin display panels, such as liquid crystal panels and plasma display panels, enabling a decrease in the thickness of the image display device. Because the liquid crystal display devices use liquid crystal panels that do not emit light by themselves, backlight units are required as separate lighting devices. The backlight units can be generally categorized into a direct backlight unit and an edge light backlight unit, depending on their mechanism. An edge light backlight unit includes a light guide plate for guiding light from a light source disposed at the edge, and an optical member for converting the light from the light guide plate to uniform planar light with optical properties and supplying the light to the liquid crystal panel. An example of the edge light backlight unit is described in Patent Document 1 indicated below.

Patent Document 1: Japanese Patent Application Laid-Open No. 2009-276708

### PROBLEM TO BE SOLVED BY THE INVENTION

Patent Document 1 discloses that a prism sheet is disposed on the light output side of the light guide plate, in which the refractive index of the prism sheet and the inclination angle of the prism surface of the prism sheet are set in the predetermined numerical value ranges so as to suppress attenuation of P-polarization component. Patent Document 1 also discloses that an inclined groove is formed in the light guide plate-side surface of the prism sheet, in which the angle of incidence of the light emitted from the light guide plate with respect to the prism sheet is increased by means of the inclination angle of the inclined groove.

However, even if an approach is adopted whereby, as described above, the refractive index of the prism sheet and the inclination angle of the prism surface are set in predetermined numerical value ranges, and also an inclined groove is formed in the light guide plate-side surface of the prism sheet, there still remains the possibility that, depending on the output angle of the output light from the light guide plate, attenuation of P-polarization component may fail to be suppressed sufficiently. Accordingly, the approach still leaves room for improvement.

### DISCLOSURE OF THE PRESENT INVENTION

The present invention has been made in view of the above-described circumstances, and an object of the present invention is to increase light utilization efficiency.

### Means for Solving the Problem

A lighting device according to the present invention includes a light source; a light guide plate having a square plate shape with outer peripheral end surfaces including a pair of end surfaces constituting opposite sides, one of the pair of end surfaces being a light incident surface on which light emitted from the light source becomes incident, the other of the pair of end surfaces being a non-light input opposite surface on which the light from the light source does not become incident, and one plate surface of the light guide plate being a light emission surface through which light is emitted; a prism sheet disposed on the light emission surface side with respect to the light guide plate, the prism sheet including a base member having light transmissivity, a light input-side prism portion formed on a light input-side plate surface which is a plate surface of the base member on which the light from the light guide plate becomes incident, and including a plurality of light input-side unit prisms extending in parallel with the light incident surface and disposed side by side, and a light output-side prism portion formed on a light output-side plate surface which is a plate surface of the base member on the opposite side from the light input-side plate surface and from which light is emitted, and including a plurality of light output-side unit prisms extending in parallel with the light incident surface and disposed side by side; and an incidence angle control structure for controlling an incidence angle of light with respect to a first light output-side inclined surface disposed on the non-light input opposite surface side with respect to an apex portion in each of the light output-side unit prism, the incidence angle control structure causing the first light output-side inclined surface, a first light input-side inclined surface disposed on the light incident surface side with respect to the apex portion in each of the light input-side unit prisms, and a second light input-side inclined surface disposed on the non-light input opposite surface side with respect to the apex portion in each of the light input-side unit prisms to make inclination angles with respect to the plate surface of the base member, the inclination angles having magnitudes such that a light incidence angle with respect to the first light output-side inclined surface is in an angle range including the Brewster's angle.

First, the light emitted from the light source becomes incident on the light incident surface of the light guide plate, and, after being propagated in the light guide plate, is emitted from the light emission surface. The light emitted from the light emission surface becomes incident on the light input-side unit prisms constituting the light input-side prism portion disposed on the light input-side plate surface of the base member in the prism sheet disposed on the light emission surface side of the light guide plate, and is then emitted from the light output-side unit prisms constituting the light output-side prism portion disposed on the light output-side plate surface of the base member after having passed through the base member.

Specifically, when the output light from the light guide plate becomes incident on the first light input-side inclined surface disposed on the light incident surface side with respect to the apex portion in the light input-side unit prism, the light is refracted at an angle based on the inclination angle of the first light input-side inclined surface. The light that passes through the light input-side unit prisms is totally reflected by the second light input-side inclined surface disposed on the non-light input opposite surface side with respect to the apex portion in the light input-side unit prisms, whereby the light travels toward the base member and the light output-side unit prism while being angled based on the inclination angle of the second light input-side inclined surface. The light that has passed through the base member and the light output-side unit prisms, when emitting from the first light output-side inclined surface disposed on the non-light input opposite surface side with respect to the apex portion in the light output-side unit prisms, is refracted at an angle based on the inclination angle of the first light output-side inclined surface, whereby the travel direction of the light is angled so as to approach the normal direction to the plate surface of the base member.

The incidence angle control structure causes the inclination angles of the first light input-side inclined surface and the second light input-side inclined surface of the light input-side unit prisms, and the inclination angle of the first light output-side inclined surface of the light output-side unit prisms to have magnitudes such that the light incidence angle with respect to the first light output-side inclined surface is in an angle range including the Brewster's angle. Accordingly, the light that passes through the light output-side unit prisms and travels toward the first light output-side inclined surface has an incidence angle with respect to the first light output-side inclined surface which is in the angle range including the Brewster's angle. Accordingly, with respect to the P-polarization component of the light that travels toward the first light output-side inclined surface, there is hardly any attenuation by being reflected by the first light output-side inclined surface, so that the light is emitted from the first light output-side inclined surface with high efficiency. In addition, the light supplied to the light output-side unit prisms is angled in advance based on the inclination angles of the first light input-side inclined surface and the second light input-side inclined surface of the light input-side unit prisms. Accordingly, compared with conventional examples, attenuation of P-polarization component can be suppressed appropriately in accordance with the output angle of the output light from the light guide plate. In this way, high light utilization efficiency can be achieved.

Embodiments of the lighting device according to the present invention may preferably have the following configurations.

(1) The incidence angle control structure may be configured such that the light incidence angle with respect to the first light output-side inclined surface is in an angle range in which a reflectance of a P-polarization component of light on the first light output-side inclined surface becomes not more than 1%. In this way, the P-polarization component of the light that passes through the light output-side unit prisms and travels toward the first light output-side inclined surface can be emitted from the first light output-side inclined surface with higher efficiency, whereby higher light utilization efficiency can be obtained.

(2) The prism sheet may have a refractive index of 1.585; and the incidence angle control structure may be configured such that the light incidence angle with respect to the first light output-side inclined surface is in an angle range of 28° to 34.5°. When the refractive index of the prism sheet is 1.585, the Brewster's angle of the light with respect to the first light output-side inclined surface becomes approximately 32.2°. As described above, when the incidence angle control structure is configured such that the incidence angle of light with respect to the first light output-side inclined surface is in the angle range of 28° to 34.5° including the Brewster's angle, the reflectance of the P-polarization component of light on the first light output-side inclined surface becomes not more than 1%, whereby higher light utilization efficiency can be obtained.

(3) The prism sheet may have a refractive index of 1.49; and the incidence angle control structure may be configured such that the light incidence angle with respect to the first light output-side inclined surface is in an angle range of 28° to 37°. When the refractive index of the prism sheet is 1.49, the Brewster's angle of light with respect to the first light output-side inclined surface light becomes approximately 33.9°. As described above, when the incidence angle control structure is configured such that the incidence angle of light with respect to the first light output-side inclined surface is in the angle range of 28° to 37° including the Brewster's angle, the reflectance of the P-polarization component of light on the first light output-side inclined surface becomes not more than 1%, whereby higher light utilization efficiency can be obtained.

(4) The light input-side unit prisms may be formed such that the inclination angle of the second light input-side inclined surface is relatively smaller than the inclination angle of the first light input-side inclined surface, whereas the light output-side unit prisms may each include a second light output-side inclined surface on the light incident surface side with respect to the apex portion of a corresponding one of the light output-side unit prisms, and may be formed such that the inclination angle of the first light output-side inclined surface is relatively smaller than the inclination angle of the second light output-side inclined surface. The light that propagates in the light guide plate, and the light that has been emitted from the light guide plate include components travelling from the light incident surface side toward the non-light input opposite surface side. In this regard, in the light input-side unit prisms and the light output-side unit prisms, the inclination angles of the second light input-side inclined surface and the first light output-side inclined surface, both disposed on the non-light input opposite surface side with respect to the apex portion, are made relatively smaller than the inclination angles of the first light input-side inclined surface and the second light output-side inclined surface, both disposed on the light incident surface side with respect to the apex portion, so that the extending surface distance of the second light input-side inclined surface and the first light output-side inclined surface is relatively large. Accordingly, the light caused to be emitted from the light guide plate by the second light input-side inclined surface and the first light output-side inclined surface and becoming incident on the prism sheet can be more efficiently angled. In this way, light utilization efficiency can be increased even further.

(5) The light output-side unit prisms may be formed such that the inclination angle of the second light output-side inclined surface is relatively greater than the angle made by light totally reflected by the second light input-side inclined surface with respect to the plate surface of the base member. The light totally reflected by the second light input-side inclined surface of the light input-side unit prisms travels toward the base member and the light output-side unit prism while being angled to have a predetermined angle with respect to the plate surface of the base member. Because the inclination angle of the second light output-side inclined surface of the light output-side unit prisms is made relatively larger than the above-described angle of the light totally reflected by the second light input-side inclined surface, the light totally reflected by the second light input-side inclined surface can be prevented from directly hitting the second light output-side inclined surface. In this way, the generation of reflected light due to the second light output-side inclined surface or transmitted light due to the second light output-side inclined surface can be avoided. Accordingly, the output light from the prism sheet can be made more uniform, whereby light utilization efficiency can be increased even further.

(6) The prism sheet may have a refractive index in a numerical value range of 1.49 to 1.585; and the light input-side unit prisms may have the inclination angle of the first light input-side inclined surface in an angle range of 50° to 80° and the inclination angle of the second light input-side inclined surface in an angle range of 36° to 49°, whereas the light output-side unit prisms may have the inclination angle of the first light output-side inclined surface in an angle range of 46° to 61°. In this way, the light becoming incident on the first light output-side inclined surface is angled in advance by the first light input-side inclined surface of the light input-side unit prisms having the inclination angle in the angle range of 50° to 80°, and by the second light input-side inclined surface with the inclination angle in the angle range of 36° to 49°. Accordingly, the incidence angle with respect to the first light output-side inclined surface with the inclination angle in the angle range of 46° to 61° is placed in the angle range of 28° to 37° including the Brewster's angle. In this way, the reflectance of the P-polarization component of light on the first light output-side inclined surface becomes not more than 1%, whereby higher light utilization efficiency can be obtained. This is particularly preferable when the output light from the light guide plate makes a large angle with respect to the normal to the light emission surface.

(7) The prism sheet may have a refractive index of 1.585; and the light input-side unit prism may have the inclination angle of the first light input-side inclined surface in an angle range of 50° to 80° and the inclination angle of the second light input-side inclined surface in an angle range of 36° to 48°, whereas the light output-side unit prisms may have the inclination angle of the first light output-side inclined surface in an angle range of 50° to 60°. In this way, the light that becomes incident on the first light output-side inclined surface is angled in advance by the first light input-side inclined surface of the light input-side unit prisms with the inclination angle in the angle range of 50° to 80°, and by the second light input-side inclined surface with the inclination angle in the angle range of 36° to 48°. Accordingly, the incidence angle with respect to the first light output-side inclined surface with the inclination angle in the angle range of 50° to 60° is placed in the angle range of 28° to 34.5° including the Brewster's angle (approximately 32.2°). In this way, the reflectance of the P-polarization component of light on the first light output-side inclined surface becomes not more than 1%, whereby higher light utilization efficiency can be obtained. This is particularly preferable when the output light from the light guide plate makes a large angle with respect to the normal to the light emission surface.

(8) The prism sheet may have a refractive index of 1.49; and the light input-side unit prisms may have the inclination angle of the first light input-side inclined surface in an angle range of 50° to 80° and the inclination angle of the second light input-side inclined surface in an angle range of 37° to 49°, whereas the light output-side unit prisms may have the inclination angle of the first light output-side inclined surface in an angle range of 46° to 61°. In this way, the light that becomes incident on the first light output-side inclined surface is angled in advance by the first light input-side inclined surface of the light input-side unit prisms with the inclination angle in the angle range of 50° to 80°, and by the second light input-side inclined surface with the inclination angle in the angle range of 37° to 49°. Accordingly, the incidence angle with respect to the first light output-side inclined surface with the inclination angle in the angle range of 46° to 61° is placed in the angle range of 28° to 37° including the Brewster's angle (approximately 33.9°). In this way, the reflectance of the P-polarization component of light on the first light output-side inclined surface becomes not more than 1%, whereby higher light utilization efficiency can be obtained. This is particularly preferable when the output light from the light guide plate makes a large angle with respect to the normal to the light emission surface.

(9) The light output-side unit prism may have the inclination angle of the second light output-side inclined surface in an angle range of 65° to 80°. The light totally reflected by the second light input-side inclined surface of the light input-side unit prisms travels toward the base member and the light output-side unit prisms while being angled to have a predetermined angle with respect to the plate surface of the base member. Because the inclination angle of the second light output-side inclined surface of the light output-side unit prisms is placed in the angle range of 65° to 80°, the inclination angle is relatively greater than the angle made by the light totally reflected by the second light input-side inclined surface with respect to the plate surface of the base member. Accordingly, the light totally reflected by the second light input-side inclined surface can be prevented from directly hitting the second light output-side inclined surface. In this way, the generation of reflected light due to the second light output-side inclined surface or transmitted light due to the second light output-side inclined surface can be avoided. As a result, the output light from the prism sheet can be made more uniform, whereby light utilization efficiency can be increased even further.

(10) The light guide plate may include an opposing plate surface on a plate surface thereof on the opposite side from the light emission surface, and includes an output light reflective prism portion on the opposing plate surface, and the output light reflective prism portion may include a plurality of unit reflective prisms extending in parallel with the light incident surface and disposed side by side; and the unit reflective prisms may each include an output light reflective inclined surface on the light incident surface side with respect to an apex portion of a corresponding one of the unit reflective prisms, and the output light reflective inclined surface may make an inclination angle, with respect to the opposing plate surface, having a magnitude smaller than a numerical value obtained by subtracting from 45° a critical angle of the light guide plate. First, the light emitted from the light source and that has become incident on the light incident surface is refracted by the light incident surface so as to have a refractive angle not smaller than the critical angle of the light guide plate. Then, the light that has propagated in the light guide plate and been totally reflected by the light emission surface is entirely totally reflected by the output light reflective inclined surface of the unit reflective prisms constituting the output light reflective prism portion, and does not pass through the output light reflective inclined surface. In this way, the travel direction of the light travelling toward the light emission surface is made uniform. The light totally reflected by the output light reflective inclined surface and travelling toward the light emission surface includes, in addition to light that is emitted from the light emission surface as is, light that is again totally reflected by the light emission surface. The light that has been totally reflected again by the light emission surface is totally reflected by the output light reflective inclined surface of the next and subsequent unit reflective prisms, and is eventually emitted from the light emission surface. That is, the output light from the light emission surface includes to no small extent light that has been totally reflected a plurality of times by the output light reflective inclined surface, and such light has its incidence angle with respect to the light emission surface aligned close to the critical angle. In this way, the output angle of the output light from the light emission surface is made uniform, and therefore the incidence angle of the light travelling from the light guide plate toward the prism sheet and becoming incident on the light input-side unit prisms is made uniform. Thus, the light can be efficiently provided with a light condensing effect by the prism sheet.

(11) The base member may include an unstretched film. In this way, compared with the case of using a biaxial stretch film for the base member, disturbance in polarization when the light passes through the base member can be avoided. In this way, the P-polarization component of light can be more efficiently emitted from the first light output-side inclined surface, whereby higher light utilization efficiency can be obtained.

(12) The lighting device may further include a polarization control sheet disposed between the light guide plate and the prism sheet, and the polarization control sheet may include a polarization control sheet base member having light transmissivity, a light guide plate-side prism portion formed on a light guide plate-side plate surface which is the light guide plate-side plate surface of the polarization control sheet base member and on which light from the light guide plate becomes incident, and including a plurality of light guide plate-side unit prisms extending in parallel with the light incident surface and disposed side by side, and a prism sheet-side prism portion formed on a prism sheet-side plate surface which is the prism sheet-side plate surface of the polarization control sheet base member and from which light is emitted, and including a plurality of prism sheet-side unit prisms extending in parallel with the light incident surface and disposed side by side. Each of the light guide plate-side unit prisms and the prism sheet-side unit prisms may include a pair of polarization control inclined surfaces disposed across an apex portion of each of the unit prisms and formed such that the polarization control inclined surfaces of the pair make a same inclination angle with respect to the plate surface of the polarization control sheet base member, and the same inclination angle may be smaller than the inclination angle made by the first light input-side inclined surface of the light input-side unit prisms in the prism sheet with respect to the plate surface of the base member. In this way, the output light from the light guide plate becomes incident on the light guide plate-side unit prisms constituting the light guide plate-side prism portion disposed on the light guide plate-side plate surface of the polarization control sheet base member in the polarization control sheet, and is then emitted from the prism sheet-side unit prisms constituting the prism sheet-side prism portion disposed on the prism sheet-side plate surface of the polarization control sheet base member after having passed through the polarization control sheet base member.

Generally, the reflectance of S-polarization component of incident light with respect to an inclined surface of a prism tends to increase as the incidence angle increases. In this regard, in the light guide plate-side unit prisms and the prism sheet-side unit prisms included in the polarization control sheet, the incidence angle of light with respect to each pair of the polarization control inclined surfaces disposed across the respective apex portion becomes relatively larger than the incidence angle of light with respect to the first light input-side inclined surface of the light input-side unit prisms in the prism sheet. Accordingly, the reflectance of S-polarization component of incident light with respect to the polarization control inclined surfaces of the light guide plate-side unit prisms and the prism sheet-side unit prisms is greater than the reflectance of S-polarization component of incident light with respect to the first light input-side inclined surface of the light input-side unit prisms, so that the S-polarization component can be reflected with higher efficiency by the polarization control inclined surfaces, and thereby returned to the light guide plate-side. The light returned to the light guide plate-side is again reflected, for example, while travelling toward the prism sheet side, whereby some of the light is converted into P-polarization component. In this way, the S-polarization component of light supplied to the prism sheet can be increased, whereby higher light utilization efficiency can be obtained. In addition, because the polarization control inclined surfaces of the light guide plate-side unit prisms and the prism sheet-side unit prisms have the same inclination angle, the output angle of the light emitted from the light guide plate and the output angle of the light emitted from the polarization control sheet become substantially parallel with each other. In this way, the same optical effect can be obtained as if the light from the light guide plate is caused to enter the prism sheet directly. As a result, the loss of light associated with the interposition of the polarization control sheet is made hard to occur, whereby high light utilization efficiency can be maintained.

(13) The light guide plate may include an opposing plate surface on a plate surface on the opposite side from the light emission surface, and the lighting device may further include a diffuser reflection sheet disposed in contact with the opposing plate surface and configured to diffuse and reflect light from the opposing plate surface. In this way, the S-polarization component of light returned to the light guide plate-side by being reflected by the unit prisms of the prism sheet is diffused and reflected by the diffuser reflection sheet, whereby some of the S-polarization component is converted into P-polarization component. In this way, the S-polarization component of light supplied to the prism sheet can be increased, whereby higher light utilization efficiency can be obtained.

In order to solve the problem, a display device according to the present invention includes the above lighting device; and a display panel for making a display using light from the lighting device.

The display device of such configuration has high utilization efficiency of the output light from the lighting device, whereby a high-brightness and high display-quality display can be made.

### Advantageous Effect of the Invention

According to the present invention, light utilization efficiency can be increased.

### BRIEF DESCRIPTION OF THE DRAWINGS

FIG. 1 is an exploded perspective view illustrating a schematic configuration of a liquid crystal display device according to a first embodiment of the present invention;

FIG. 2 is an exploded perspective view illustrating a schematic configuration of a backlight unit constituting the liquid crystal display device;

FIG. 3 is a cross sectional view illustrating a cross sectional configuration along a long-side direction (first direction, the X-axis direction) of the liquid crystal display device;

FIG. 4 is a cross sectional view illustrating a cross sectional configuration along a short-side direction (second direction, the Y-axis direction) of the liquid crystal display device;

FIG. 5 is an enlarged cross sectional view of FIG. 3 around LEDs;

FIG. 6 is a cross sectional view illustrating a cross sectional configuration along the short-side direction (second direction, the Y-axis direction) of the backlight unit constituting the liquid crystal display device;

FIG. 7 is an enlarged cross sectional view of a prism sheet illustrated in FIG. 6;

FIG. 8 is a graph illustrating a relationship between light incidence angle in the prism sheet and the reflectance of S-polarization component and P-polarization component;

FIG. 9 is a table illustrating a relationship between a refractive index n1 of the prism sheet, a light incidence angle φ6 with respect to a first light output-side inclined surface, an angle φ8 of output light on the first light output-side inclined surface with respect to a direction normal to the plate surface of a base member, an output angle φ0 of output light from the light guide plate, an inclination angle θ1 of a first light input-side inclined surface with respect to the plate surface of the base member, an inclination angle θ2 of a second light input-side inclined surface with respect to the plate surface of the base member, and an inclination angle θ4 of the first light output-side inclined surface with respect to the plate surface of the base member;

FIG. 10 is a graph illustrating a brightness angle distribution in regard to the first direction in a case where an inclination angle θ5 of a second light output-side inclined surface with respect to the plate surface of the base member is modified;

FIG. 11 is a graph illustrating changes in brightness relating to the output light from the polarizing plate when, in Comparative Experiment 1, the angle of transmission axis of the polarizing plate that transmits the output light from the prism sheet is changed in a range of 0° to 180°;

FIG. 12 is a cross sectional view illustrating a cross sectional configuration of a light guide plate, a polarization control sheet, and a prism sheet according to the second embodiment of the present invention;

FIG. 13 is an enlarged cross sectional view of the polarization control sheet illustrated in FIG. 12; and

FIG. 14 is a cross sectional view illustrating a cross sectional configuration of a light guide plate and a prism sheet according to a third embodiment of the present invention.

### BEST MODE FOR CARRYING OUT THE INVENTION

### First Embodiment

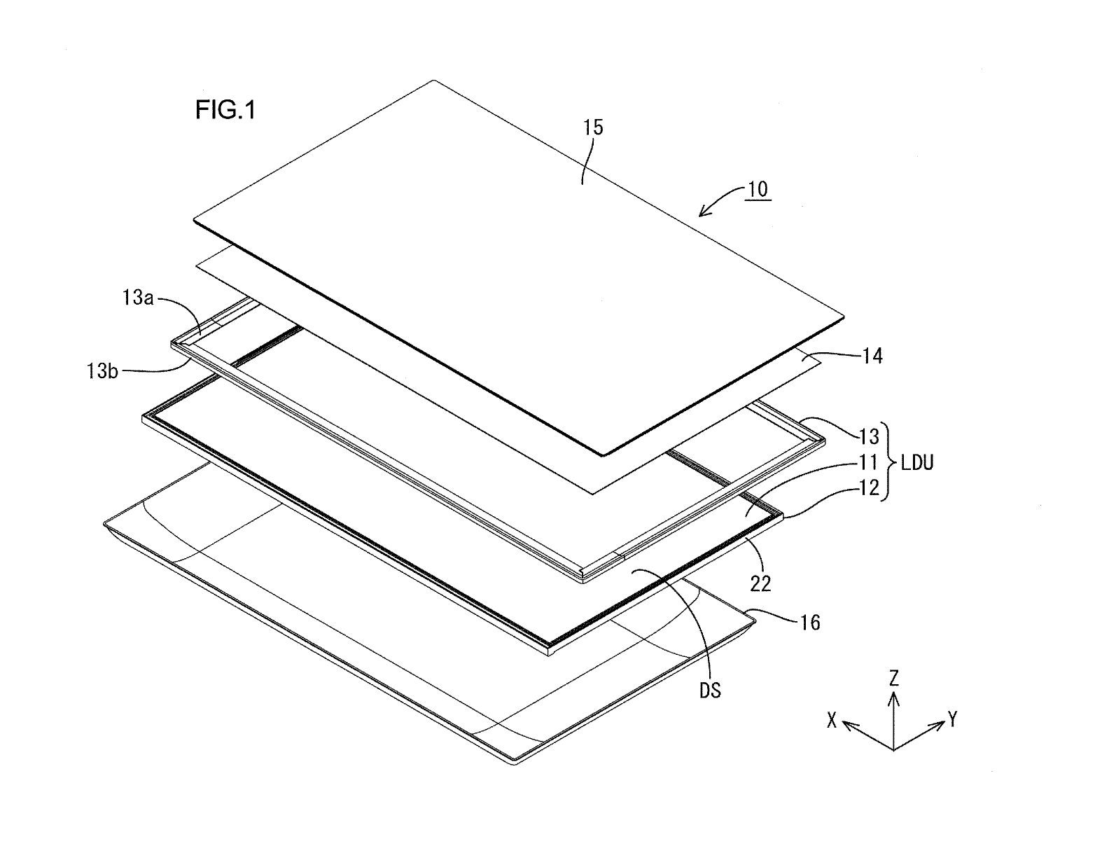

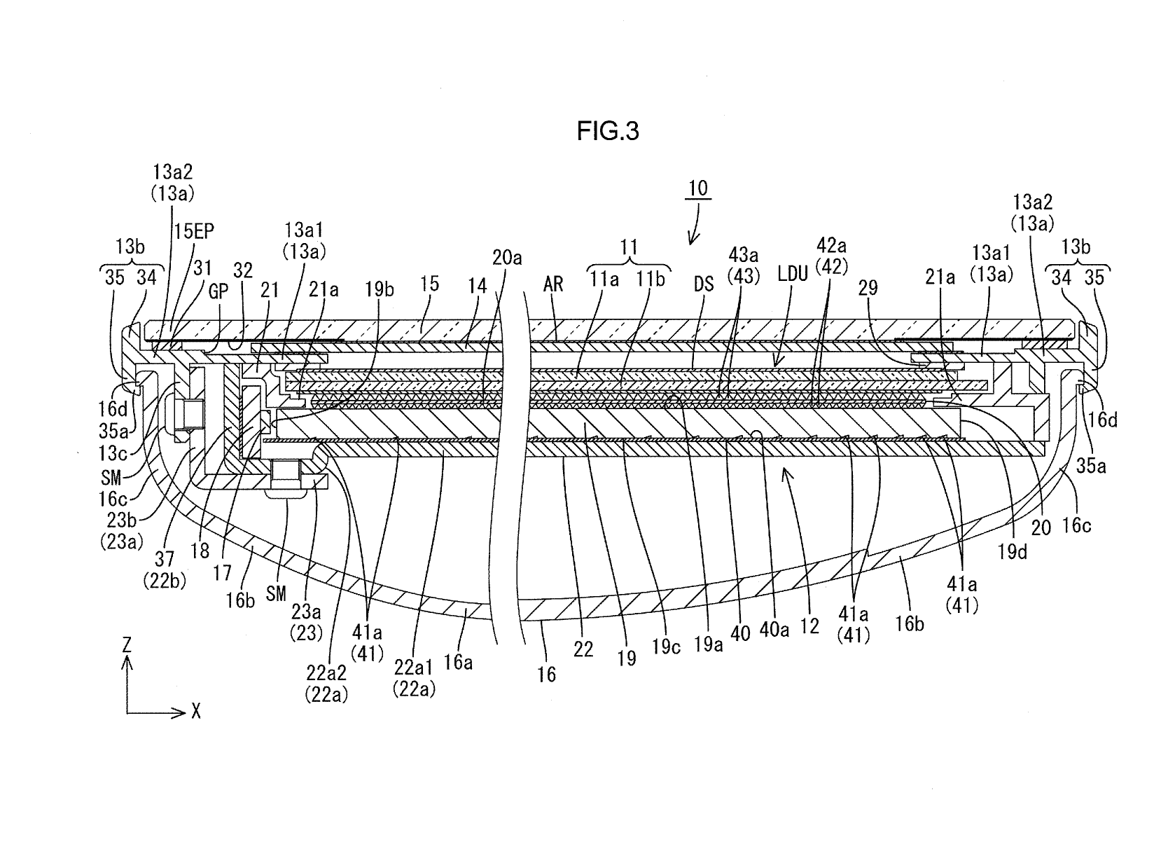

A first embodiment of the present invention will be described with reference to FIG. 1 to FIG. 11. In the present embodiment, a liquid crystal display device 10 will be described by way of example. Some of the drawings show an X-axis, a Y-axis, and a Z-axis drawn such that the respective axis directions correspond to the directions indicated in each drawing. With regard to a top-bottom direction, reference is made to FIG. 3 to FIG. 5, where the top of the drawings will be referred to as a front side and the bottom as a back side.

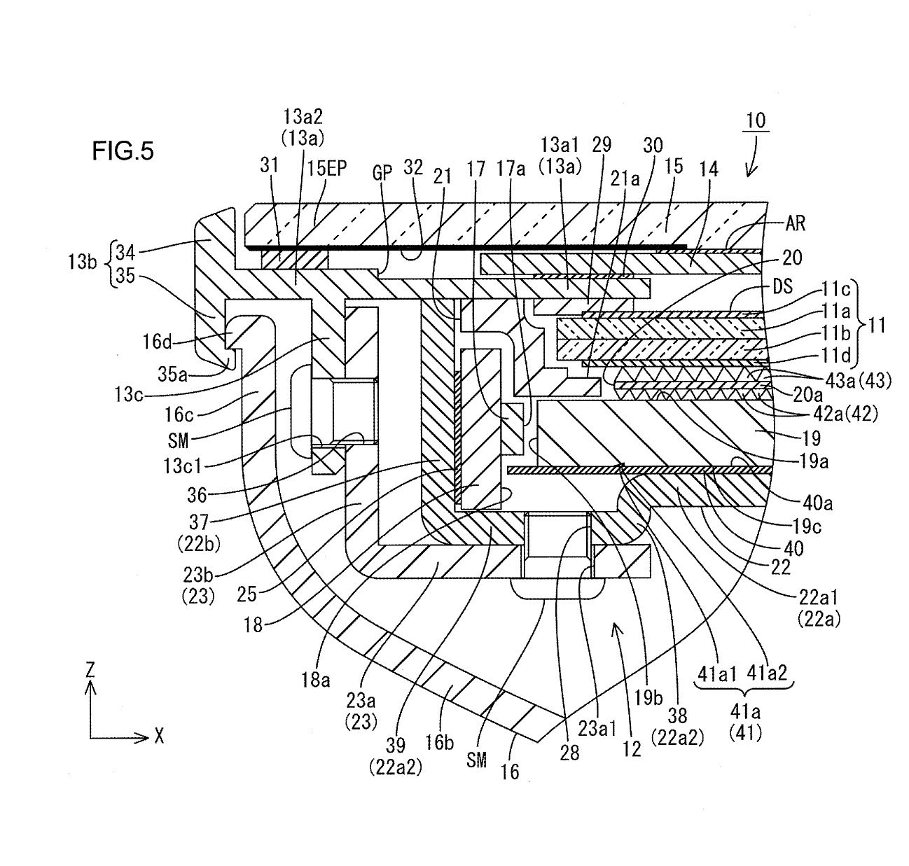

The liquid crystal display device 10, as illustrated in FIG. 1, has a rectangular shape as a whole as viewed in plan, and includes a liquid crystal display unit LDU, which is a core component, to which components such as a touch panel 14, a cover panel (protection panel, cover glass) 15, and a casing 16 are assembled. The liquid crystal display unit LDU includes a liquid crystal panel (display panel) 11 with a display surface DS disposed on the front side for displaying images; a backlight unit (lighting device) 12 disposed on the back side of the liquid crystal panel 11 for emitting light toward the liquid crystal panel 11; and a frame (housing member) 13 that presses the liquid crystal panel 11 from the front side, i.e., the opposite side (display surface DS side) from the backlight unit 12 side. The touch panel 14 and the cover panel 15 are both housed in the frame 13 of the liquid crystal display unit LDU from the front side, with the outer peripheral portions (including outer peripheral ends) received by the frame 13 from the back side. The touch panel 14 is disposed at a predetermined interval on the front side with respect to the liquid crystal panel 11, with a plate surface on the back side (inner side) of the touch panel 14 providing an opposing surface opposed to the display surface DS. The cover panel 15 is disposed so as to overlap the touch panel 14 on the front side, with a plate surface on the back side (inner side) providing an opposing surface opposed to a plate surface of the touch panel 14 on the front side. Between the touch panel 14 and the cover panel 15, an antireflection film AR is disposed (see FIG. 5). The casing 16 is assembled onto the frame 13 so as to cover the liquid crystal display unit LDU from the back side. Of the constituent components of the liquid crystal display device 10, a part of the frame 13 (a collar portion 13b, which will be described later), the cover panel 15, and the casing 16 constitute the exterior view of the liquid crystal display device 10. The liquid crystal display device 10 according to the present embodiment may be used for various electronic devices (not illustrated), such as portable telephones (including smartphones and the like); notebook computers (including tablet notebook computers and the like); portable information terminals (including electronic books and PDA); digital photo frames; portable game machines; and electronic-ink papers. Accordingly, the liquid crystal panel 11 of the liquid crystal display device 10 has a screen size on the order of from several inches to a little over 10 inches, which are generally considered to be classified as being small or mid-to-small size.

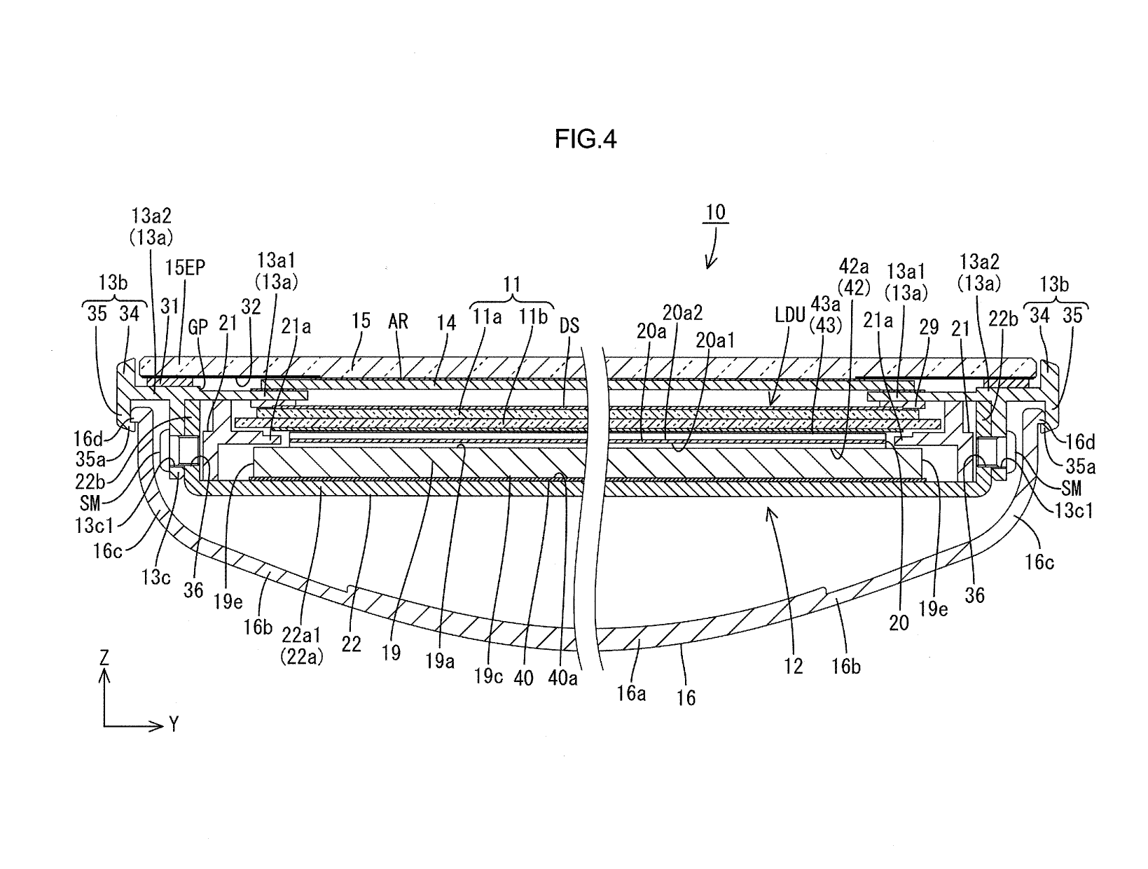

First, the liquid crystal panel 11 of the liquid crystal display unit LDU will be described in detail. The liquid crystal panel 11, as illustrated in FIG. 3 and FIG. 4, has a rectangular shape as viewed in plan. The liquid crystal panel 11 includes a pair of substantially transparent glass substrates 11a and 11b having excellent light transmissivity, and a liquid crystal layer (not illustrated) which is disposed between the substrates 11a and 11b and which contains liquid crystal molecules of a substance the optical characteristics of which varying in accordance with the application of an electric field. The substrates 11a and 11b are fixed to each other using a sealing material which is not illustrated, with a gap corresponding to the thickness of the liquid crystal layer maintained therebetween. The liquid crystal panel 11 has a display area in which an image is displayed (a center portion surrounded by a plate surface light-blocking layer 32, which will be described later), and a non-display area (an outer peripheral portion overlapping the plate surface light-blocking layer 32, as will be described later) which forms a picture frame-like shape enclosing the display area and in which no image is displayed. As illustrated in FIG. 5, to the outer surface sides of the substrates 11a and 11b, a pair of polarizing plates 11c and 11d is fixed. The pair of polarizing plates 11c and 11d is arranged in a so-called cross Nicol arrangement where the polarization directions are orthogonal to each other (i.e., differing by 90°). That is, the liquid crystal panel 11 is in normally black mode with a black display when not energized (when no voltage is being applied to the pixel electrodes). Of the pair of polarizing plates 11c and 11d, the polarizing plate 11d on the back side (prism sheet 20 side) has its polarization direction aligned with the X-axis direction (first direction). On the other hand, the polarizing plate 11c on the front side (light output side; observer side) has its polarization direction aligned with the Y-axis direction (second direction). Of the liquid crystal panel 11, the long-side direction is aligned with the X-axis direction, the short-side direction is aligned with the Y-axis direction, and the thickness direction is aligned with the Z-axis direction.

Of the substrates 11a and 11b, the front side (front surface side) is a CF substrate 11a, and the back side (rear surface side) is an array substrate 11b. On the inner surface side of the array substrate 11b (the liquid crystal layer side; the side of the surface opposite the CF substrate 11a), a number of thin-film transistors (TFT), which are switching components, and pixel electrodes are provided side by side. Around the TFTs and pixel electrodes, gate wiring and source wiring are disposed in a lattice in an enclosing manner. The wirings are supplied with predetermined image signals from a control circuit, which is not illustrated. The pixel electrodes disposed in a square region surrounded by the gate wiring and source wiring include transparent electrodes of indium tin oxide (ITO) or zinc oxide (ZnO), for example.

On the other hand, on the CF substrate 11a, there are provided a number of color filters side by side at positions corresponding to the respective pixels. The color filters are arranged such that the three colors of R, G, and B are alternately arranged. Between the color filters, a light-blocking layer (black matrix) for preventing mixing of the colors is formed. On surfaces of the color filters and the light-blocking layer, counter electrodes opposing the pixel electrodes on the array substrate 11b side are provided. The CF substrate 11a is slightly smaller than the array substrate 11b. On the inner surface side of each of the substrates 11a and 11b, there is formed an alignment film for the alignment of the liquid crystal molecules included in the liquid crystal layer.

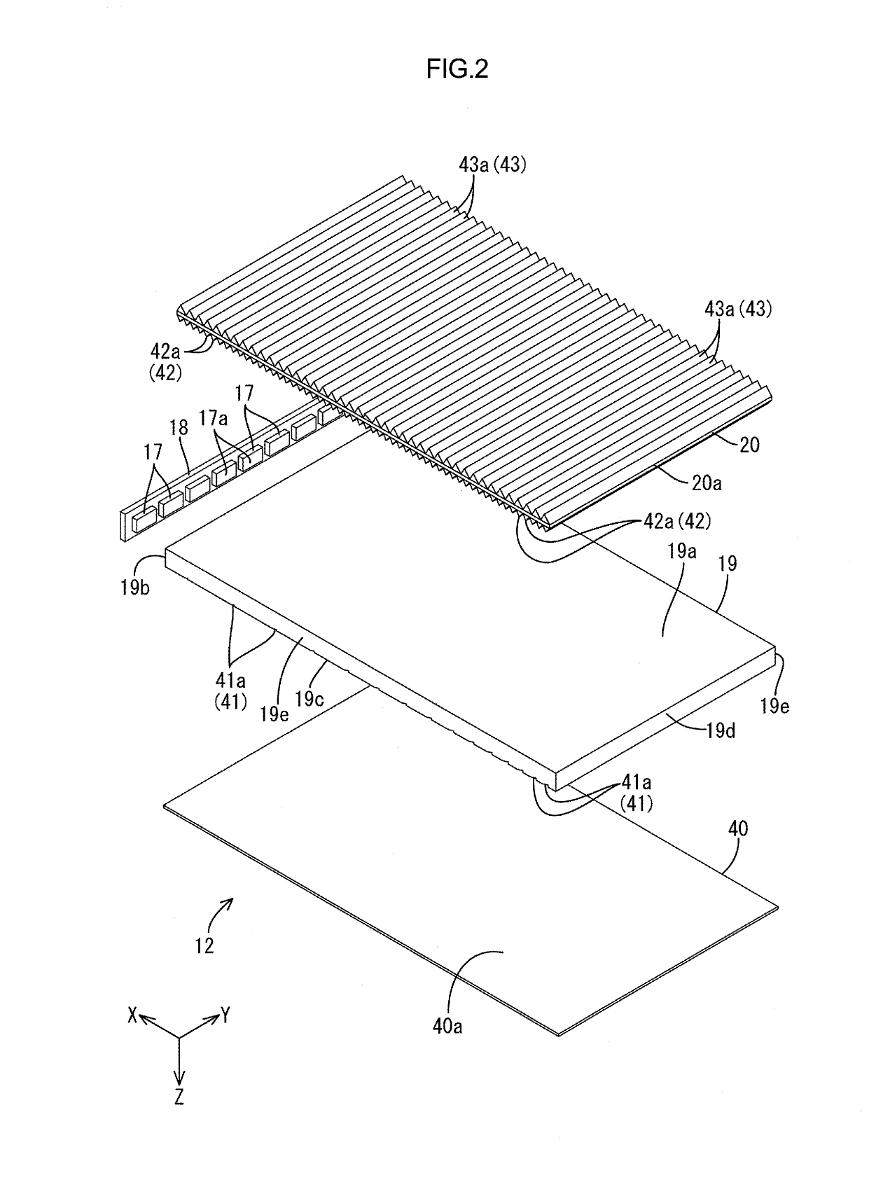

The backlight unit 12 of the liquid crystal display unit LDU will be described in detail. The backlight unit 12, as illustrated in FIG. 1, has as a whole a rectangular, substantially block-like shape as viewed in plan, similar to the liquid crystal panel 11. The backlight unit 12, as illustrated in FIG. 2 to FIG. 4, includes: light emitting diodes (LEDs) 17 as a light source; an LED board (light source board) 18 with the LEDs 17 mounted thereon; a light guide plate 19 that guides light from the LEDs 17; a reflection sheet (reflective member) 40 that reflects light from the light guide plate 19; a prism sheet 20, which is a type of an optical sheet, stacked on the light guide plate 19; a light-blocking frame 21 pressing the light guide plate 19 from the front side; a chassis 22 housing the LED board 18, the light guide plate 19, the prism sheet 20, and the light-blocking frame 21; and a heat-dissipating member 23 attached to the outer surface of the chassis 22. The backlight unit 12 is a one-side light input type, edge light (side light) backlight unit in which the LEDs 17 (LED board 18) are distributed only on one end on the short-side sides of the outer peripheral portion of the backlight unit.

The LEDs 17, as illustrated in FIG. 2, FIG. 3, and FIG. 5, are configured of LED chips sealed with resin material on a board portion fixed to the LED board 18. The LED chips mounted on the board portion have a single main emission wavelength, and, specifically, emit the single color of blue. Meanwhile, the resin material with which the LED chips are sealed has a fluorescent material dispersed and blended therein that emits a predetermined color when excited by the blue light from the LED chips, so that the resin material, as a whole, emits almost white light. The fluorescent material may include a yellow fluorescent material that emits yellow light, a green fluorescent material that emits green light, and a red fluorescent material that emits red light, which may be used either in an appropriate combination or individually. The LEDs 17 are of so-called top-emitting LEDs where the surface on the opposite side from the mounting surface with respect to the LED board 18 provides light emitting surfaces 17a.

The LED board 18, as illustrated in FIG. 2, FIG. 3, and FIG. 5, has a longitudinal plate shape extending along the Y-axis direction (the short-side direction of the light guide plate 19 and the chassis 22). The LED board 18 is housed in the chassis 22 in a position such that the plate surface of the LED board is parallel with the Y-axis direction and the Z-axis direction; i.e., orthogonal to the plate surfaces of the liquid crystal panel 11 and the light guide plate 19. That is, the LED board 18 is positioned with the long-side direction and the short-side direction of its plate surface respectively aligned with the Y-axis direction and the Z-axis direction, and with the plate thickness direction orthogonal to the plate surface aligned with the X-axis direction. The LED board 18 is disposed with its inward-facing plate surface (mounting surface 18a) opposed to the end surface (a light incident surface 19b which will be described later) on one of the short sides of the light guide plate 19, via a predetermined interval in the X-axis direction. Accordingly, the direction in which the LEDs 17 and LED board 18 and the light guide plate 19 are disposed is substantially aligned with the X-axis direction. The LED board 18 has a length dimension substantially the same as or greater than a short-side dimension of the light guide plate 19, and is attached to one end on the short-side sides of the chassis 22, as will be described later.

As illustrated in FIG. 5, the LEDs 17 of the above-described configuration are surface-mounted on a mounting surface 18a on the inner side of the LED board 18, i.e., on its plate surface facing the light guide plate 19 (the opposing surface with respect to the light guide plate 19). On the mounting surface 18a of the LED board 18, a plurality of LEDs 17 is arranged in parallel at predetermined intervals in a row (linearly) along the length direction (the Y-axis direction). That is, it may be said that a plurality of LEDs 17 is arranged in parallel in an intermittent manner along the short-side direction at one end on the short-side sides of the backlight unit 12. The adjacent LEDs 17 have substantially equal arrangement intervals (arrangement pitch). On the mounting surface 18a of the LED board 18, there is formed a wiring pattern (not illustrated) including a metal film (such as a copper foil) extending along the Y-axis direction and connecting the adjacent LEDs 17 in series across the group of LEDs 17. The wiring pattern has terminal portions formed at both ends which are connected to an external LED drive circuit, so that drive electric power can be supplied to the respective LEDs 17. The LED board 18 includes a metal base member as does the chassis 22, and has the above-described wiring pattern (not illustrated) formed on the surface of the base member via an insulating layer. The base member of the LED board 18 may include an insulating material, such as ceramics.

The light guide plate 19 is made from a synthetic resin material (for example, an acrylic resin such as PMMA) having a sufficiently higher refractive index than air, and which is substantially transparent and has excellent light transmissivity. The light guide plate 19, as illustrated in FIG. 2, has a flat sheet, almost rectangular shape similar to the liquid crystal panel 11 as viewed in plan, the plate surface being in parallel with the plate surface (display surface DS) of the liquid crystal panel 11. The light guide plate 19, on its plate surface, has the long-side direction and the short-side direction respectively aligned with the X-axis direction and the Y-axis direction, with the plate thickness direction orthogonal to the plate surface being aligned with the Z-axis direction. The light guide plate 19, as illustrated in FIG. 3 and FIG. 4, is disposed immediately under the liquid crystal panel 11 and the prism sheet 20 in the chassis 22, and has the end surface on one of the short sides of the outer peripheral end surfaces opposed to the LEDs 17 on the LED board 18 disposed on one end on the short-side sides of the chassis 22. Accordingly, the direction of arrangement of the LEDs 17 (LED board 18) and the light guide plate 19 is aligned with the X-axis direction, whereas the direction of arrangement of the prism sheet (liquid crystal panel 11) and the light guide plate 19 (overlapping direction) is aligned with the Z-axis direction. Thus, the directions of arrangement are orthogonal to each other. The light guide plate 19 has the function of introducing the light emitted from the LEDs 17 toward the light guide plate 19 along the X-axis direction (the direction of arrangement of the LEDs 17 and the light guide plate 19) from the short-side end surface, and of causing the light to propagate internally and rise toward the prism sheet 20 side (front side, light emission side) so as to be emitted via the plate surface.

Of the plate surfaces of the light guide plate 19 having the flat plate shape, the plate surface facing the front side (the surface opposed to the liquid crystal panel 11 and the prism sheet 20), as illustrated in FIG. 3 and FIG. 4, constitutes a light emission surface 19a for emitting the internal light toward the prism sheet 20 and the liquid crystal panel 11. Of the outer peripheral end surfaces of the light guide plate 19 adjacent to the plate surfaces, one end surface (on the left side in FIG. 3) of the end surfaces on the pair of short sides, which are longitudinal along the Y-axis direction (the direction of arrangement of the LEDs 17; the long-side direction of the LED board 18), is opposed to the LEDs 17 (LED board 18) via a predetermined space, as illustrated in FIG. 5. The end surface constitutes the light incident surface 19b on which the light emitted from the LEDs 17 becomes incident. In other words, the end surface is an LED-opposing end surface (light source-opposing end surface) opposed to the LEDs 17. The light incident surface 19b is parallel with the Y-axis direction and the Z-axis direction, and substantially orthogonal to the light emission surface 19a. The direction of arrangement of the LEDs 17 and the light incident surface 19b (light guide plate 19) is aligned with the X-axis direction, and parallel with the light emission surface 19a. Of the end surfaces on the pair of short sides of the outer peripheral end surfaces of the light guide plate 19, the other end surface on the opposite side from the light incident surface 19b (the end surface constituting the opposite side with respect to the light incident surface 19b) is a non-light input opposite surface 19d on which the light from the LEDs 17 does not become incident. The non-light input opposite surface 19d is parallel with the light incident surface 19b. On the other hand, the end surfaces on the pair of long sides adjacent to both the light incident surface 19b and the non-light input opposite surface 19d (the pair of end surfaces which are opposite sides to each other and not including the light incident surface 19b) constitute non-light input side surfaces 19e on which the light from the LEDs 17 does not become incident. The pair of non-light input side surfaces 19e is parallel with the X-axis direction (the direction of arrangement of the LEDs 17 and the light guide plate 19) and the Z-axis direction. Of the outer peripheral end surfaces of the light guide plate 19, the three end surfaces except for the light incident surface 19b, i.e., the non-light input opposite surface 19d and the pair of non-light input side surfaces 19e, are, as illustrated in FIG. 2, LED non-opposing end surfaces (light source non-opposing end surfaces) respectively not opposed to the LEDs 17. When the material of the light guide plate 19 is resin, such as polycarbonate (PC), the refractive index is approximately 1.59, so that the critical angle is approximately 38.97°, for example. The light emitted from the LEDs 17 and becoming incident on the light incident surface 19b of the light guide plate 19 is refracted by the light incident surface 19b so as to have a refractive angle not smaller than the critical angle (38.97°) of the light guide plate 19. Accordingly, the light that has entered the light guide plate 19 via the light incident surface 19b has an incidence angle with respect to the light emission surface 19a or an opposing plate surface 19c which is not smaller than the critical angle without fail. The light is therefore totally reflected by the light emission surface 19a or the opposing plate surface 19c, and accordingly propagates in the light guide plate 19. In the following description, of the outer peripheral end surfaces of the light guide plate 19, the direction (the X-axis direction) along the pair of end surfaces (end surfaces on the long sides; the non-light input side surfaces 19e) forming opposite sides and not including the light incident surface 19b will be referred to as a “first direction”; and the direction (the Y-axis direction) along the pair of end surfaces (the end surfaces on the short sides; the light incident surface 19b and the non-light input opposite surface 19d) forming opposite sides and including the light incident surface 19b will be referred to as a “second direction”.

Of the plate surfaces of the light guide plate 19, the opposing plate surface 19c on the opposite side from the light emission surface 19a is substantially entirely covered with a reflection sheet 40. As illustrated in FIG. 3 and FIG. 4, the reflection sheet 40 is configured to reflect the light from the light guide plate 19 so as to rise toward the front side, i.e., toward the light emission surface 19a. In other words, the reflection sheet 40 is sandwiched between a bottom plate 22a of the chassis 22 and the light guide plate 19. The reflection sheet 40 includes a reflective surface 40a opposed to the opposing plate surface 19c of the light guide plate 19 and which reflects light. Of the reflection sheet 40, the end on the light incident surface 19b side of the light guide plate 19 is, as illustrated in FIG. 5, extended to the outside beyond the light incident surface 19b, i.e., toward the LEDs 17. The extended portion reflects the light from the LEDs 17, whereby the incidence efficiency of light on the light incident surface 19b can be increased. The opposing plate surface 19c of the light guide plate 19 is, as illustrated in FIG. 3 and FIG. 5, provided with an output light reflective prism portion 41 for reflecting the light propagating inside the light guide plate 19 and thereby promoting emission of the light via the light emission surface 19a. The output light reflective prism portion 41, on the opposing plate surface 19c of the light guide plate 19, extends along the second direction (the Y-axis direction), and includes a plurality of grooved unit reflective prisms 41a having a substantially triangular (substantially V-shaped) cross sectional shape and disposed side by side along the first direction (the X-axis direction) in an intermittent manner. The unit reflective prisms 41a include an output light reflective inclined surface 41a1 inclined with respect to the plate thickness direction of the light guide plate 19, i.e., with respect to the direction (the Z-axis direction) orthogonal to both the first direction and the second direction, and a parallel surface 41a2 parallel with the plate thickness direction of the light guide plate 19. The output light reflective inclined surface 41a1 is configured to reflected light so as to produce light the incidence angle of which with respect to the light emission surface 19a does not exceed the critical angle, thereby promoting the emission of the light via the light emission surface 19a. The multiple unit reflective prisms 41a along the first direction are disposed such that, with respect to the first direction, their arrangement intervals (arrangement pitch) become gradually smaller and such that the areas of the output light reflective inclined surface 41a1 and the parallel surface 41a2 become gradually greater with increasing distance from the LEDs 17 (light incident surface 19b). In this way, the output light from the light emission surface 19a is controlled to have a uniform distribution in the plane of the light emission surface 19a. In the multiple unit reflective prisms 41a along the first direction, the output light reflective inclined surface 41a1 has a constant inclination angle θ7 with respect to the opposing plate surface 19c.

The prism sheet 20, as illustrated in FIG. 2 to FIG. 4, has a rectangular shape as viewed in plan, similarly to the liquid crystal panel 11 and the chassis 22. The prism sheet 20 is disposed between the liquid crystal panel 11 and the light guide plate 19 so as to cover the light emission surface 19a of the light guide plate 19 from the front side (light emission side). In this way, the prism sheet 20 transmits the output light from the light guide plate 19 and causes the transmitted light to be emitted toward the liquid crystal panel 11, while providing the transmitted light with a light condensing effect. The prism sheet 20 will be described in detail later.

The light-blocking frame 21, as illustrated in FIG. 3 and FIG. 4, is formed in a substantially frame-like (picture frame-like) shape extending along the outer peripheral portions of the light guide plate 19 (outer peripheral ends), and configured to press the outer peripheral portions of the light guide plate 19 from the front side substantially throughout the peripheries. The light-blocking frame 21 is made from synthetic resin and has a surface rendered to exhibit the color of black, for example, so as to provide a light-blocking property. The light-blocking frame 21 includes an inner end 21a disposed between the outer peripheral portions of the light guide plate 19 and LEDs 17 and the respective outer peripheral portions (outer peripheral ends) of the liquid crystal panel 11 and prism sheet 20, throughout the peripheries, the inner end 21a thus dividing the elements so as to be optically independent from each other. In this way, the light emitted from the LEDs 17 but not entering the light incident surface 19b of the light guide plate 19, or the light leaking out via the non-light input opposite surface 19d and the non-light input side surfaces 19e can be blocked from directly entering the respective outer peripheral portions (particularly the end surfaces) of the liquid crystal panel 11 or the prism sheet 20. Of the light-blocking frame 21, the three side portions (the pair of long-side portions and the short-side portion on the opposite side from the LED board 18 side) that do not overlap the LEDs 17 and the LED board 18 as viewed in plan include portions rising from the bottom plate 22a of the chassis 22 and portions supporting the frame 13 from the back side. On the other hand, the short-side portion overlapping the LEDs 17 and the LED board 18 as viewed in plan is formed so as to cover the end of the light guide plate 19 and the LED board 18 (LEDs 17) from the front side and bridging between the pair of long-side portions. The light-blocking frame 21 is fixed to the chassis 22, which will be described below, using a fixing means, such as screw members which are not illustrated.

The chassis 22 is made from a metal plate having high heat conductivity, such as an aluminum plate or an electrogalvanized steel plate (SECC). As illustrated in FIG. 3 and FIG. 4, the chassis 22 includes a bottom plate 22a having a rectangular shape as viewed in plan, similarly to the liquid crystal panel 11, and side plates 22b rising respectively from the outer ends of the sides (a pair of long sides and a pair of short sides) of the bottom plate 22a toward the front side. The chassis 22 (bottom plate 22a) has its long-side direction aligned with the X-axis direction and its short-side direction aligned with the Y-axis direction. The bottom plate 22a includes a light guide plate support portion 22a1 constituting most of the bottom plate 22a and supporting the light guide plate 19 from the back side (the opposite side from the light emission surface 19a side), and a board housing portion 22a2 on the LED board 18 side end bulging in a stepped manner toward the back side. The board housing portion 22a2, as illustrated in FIG. 5, has a substantially L-shaped cross section, and includes a rising portion 38 bent from the end of the light guide plate support portion 22a1 and rising toward the back side, and a housing bottom portion 39 bent from the rising end of the rising portion 38 and protruding toward the opposite side from the light guide plate support portion 22a1. The position of the rising portion 38 bent from the end of the light guide plate support portion 22a1 is on the opposite side from the LEDs 17 side (closer to the center of the light guide plate support portion 22a1) with respect to the light incident surface 19b of the light guide plate 19. From the protruding tip end of the housing bottom portion 39, the side plates 22b on the long sides are formed and bent so as to rise toward the front side. To the side plate 22b on the short side continuous with the board housing portion 22a2, the LED board 18 is attached, the side plate 22b constituting a board attachment portion 37. The board attachment portion 37 includes an opposing surface opposed to the light incident surface 19b of the light guide plate 19, and the LED board 18 is attached to the opposing surface. The LED board 18 has a plate surface on the opposite side from the mounting surface 18a on which the LEDs 17 are mounted, the plate surface being fixed in contact with the inner-side plate surface of the board attachment portion 37, via a board fixing member 25, such as a double-sided tape. The attached LED board 18 maintains a slight gap from the inner-side plate surface of the housing bottom portion 39 constituting the board housing portion 22a2. To the back-side plate surface of the bottom plate 22a of the chassis 22, there are attached a liquid crystal panel drive circuit board (not illustrated) for controlling the driving of the liquid crystal panel 11; an LED drive circuit board (not illustrated) for supplying drive electric power to the LEDs 17; and a touch panel drive circuit board (not illustrated) for controlling the driving of the touch panel 14, for example.

The heat-dissipating member 23 includes a metal plate having excellent heat conductance, such as an aluminum plate. As illustrated in FIG. 3, the heat-dissipating member 23 extends along one end on the short-side sides of the chassis 22, specifically along the board housing portion 22a2 housing the LED board 18. The heat-dissipating member 23, as illustrated in FIG. 5, has a substantially L-shaped cross section, and includes a first heat-dissipating portion 23a parallel and in contact with the outer surface of the board housing portion 22a2, and a second heat-dissipating portion 23b parallel with the outer surface of the side plate 22b (board attachment portion 37) continuous with the board housing portion 22a2. The first heat-dissipating portion 23a has a thin-and-long, flat plate shape extending along the Y-axis direction, and includes a front side-facing plate surface which is parallel with the X-axis direction and the Y-axis direction and which is abutted on the outer surface of the housing bottom portion 39 of the board housing portion 22a2, substantially throughout the length of the housing bottom portion 39. The first heat-dissipating portion 23a is screwed onto the housing bottom portion 39 using a screw member SM, and includes a screw insertion hole 23a1 for inserting the screw member SM. The housing bottom portion 39 has a screw hole 28 formed therein for threadedly engaging the screw member SM. In this way, the heat generated from the LEDs 17 can be transmitted via the LED board 18, the board attachment portion 37, and the board housing portion 22a2 to the first heat-dissipating portion 23a. Specifically, a plurality of screw members SM are attached to the first heat-dissipating portion 23a, side by side in an intermittent manner along the direction in which the first heat-dissipating portion 23a extends. The second heat-dissipating portion 23b has a thin-and-long, flat plate shape extending along the Y-axis direction, and is disposed with its plate surface parallel with the Y-axis direction and the Z-axis direction and facing the inner side opposed to the outer-side plate surface of the board attachment portion 37 via a predetermined gap.

Next, the frame 13 of the liquid crystal display unit LDU will be described. The frame 13 is made from a metal material having excellent heat conductivity, such as aluminum. As shown in FIG. 1, the frame 13 as a whole has a rectangular, substantially frame-like (picture frame-like) shape as viewed in plan, extending along the respective outer peripheral portions (outer peripheral ends) of the liquid crystal panel 11, the touch panel 14, and the cover panel 15. The frame 13 may be manufactured by press working method, for example. The frame 13, as illustrated in FIG. 3 and FIG. 4, presses the outer peripheral portion of the liquid crystal panel 11 from the front side, and holds, between the frame 13 and the chassis 22 of the backlight unit 12, the liquid crystal panel 11, the prism sheet 20, and the light guide plate 19 that are stacked on top of one another. Meanwhile, the frame 13 receives the respective outer peripheral portions of the touch panel 14 and the cover panel 15 from the back, and is disposed between the outer peripheral portions of the liquid crystal panel 11 and the touch panel 14. In this way, a predetermined gap is ensured between the liquid crystal panel 11 and the touch panel 14. Accordingly, if external force has acted on the cover panel 15 and the touch panel 14 is thereby deformed correspondingly to the cover panel 15 so as to be warped on the liquid crystal panel 11 side, the warped touch panel 14 will not readily interfere with the liquid crystal panel 11.

The frame 13, as illustrated in FIG. 3 and FIG. 4, includes: a frame-shaped portion (frame base portion; picture frame-like portion) 13a conforming to the respective outer peripheral portions of the liquid crystal panel 11, the touch panel 14, and the cover panel 15; a collar portion (tubular portion) 13b continuous with the outer peripheral end of the frame-shaped portion 13a and enclosing the touch panel 14, the cover panel 15, and the casing 16 respectively from the outer peripheral side; and an attachment plate portion 13c protruding from the frame-shaped portion 13a toward the back side and attached to chassis 22 and the heat-dissipating member 23. The frame-shaped portion 13a has a substantially plate shape including a plate surface parallel with the respective plate surfaces of the liquid crystal panel 11, the touch panel 14, and the cover panel 15, and is formed in a rectangular frame shape as viewed in plan. The frame-shaped portion 13a has a relatively greater plate thickness in the outer peripheral portion 13a2 than in the inner peripheral portion 13a1, where a step (gap) GP is formed at their boundary position. Of the frame-shaped portion 13a, the inner peripheral portion 13a1 is disposed between the outer peripheral portion of the liquid crystal panel 11 and the outer peripheral portion of the touch panel 14. On the other hand, the outer peripheral portion 13a2 receives the outer peripheral portion of the cover panel 15 from the back side. Thus, the frame-shaped portion 13a has its front side plate surface substantially entirely covered by the cover panel 15, so that the front-side plate surface is hardly exposed to the outside. In this way, even when the temperature of the frame 13 is increased by the heat from the LEDs 17, for example, the user of the liquid crystal display device 10 is prevented from readily touching the exposed location of the frame 13 directly, which is advantageous from the viewpoint of safety. As illustrated in FIG. 5, to the back-side plate surface of the inner peripheral portion 13a1 of the frame-shaped portion 13a, a buffer material 29 is fixed such that the outer peripheral portion of the liquid crystal panel 11 can be pressed from the front side while damping shocks. To the front-side plate surface of the inner peripheral portion 13a1, a first fixing member 30 is fixed so as to fix the outer peripheral portion of the touch panel 14 while damping shocks. The buffer material 29 and the first fixing member 30 are disposed at mutually overlapping positions on the inner peripheral portion 13a1 as viewed in plan. On the other hand, to the front-side plate surface of the outer peripheral portion 13a2 of the frame-shaped portion 13a, a second fixing member 31 is fixed so as to fix the outer peripheral portion of the cover panel 15 while damping shocks. The buffer material 29 and the fixing members 30 and 31 are respectively disposed extending along the side portions of the frame-shaped portion 13a except for the corner portions at the four corners thereof. The fixing members 30 and 31 may include a base member of double-sided tape having cushioning property, for example.

The collar portion 13b, as illustrated in FIG. 3 and FIG. 4, has a rectangular, short square-tube shape as a whole as viewed in plan, and includes a first collar portion 34 protruding from the outer peripheral edge of the outer peripheral portion 13a2 of the frame-shaped portion 13a toward the front side, and a second collar portion 35 protruding from the outer peripheral edge of the outer peripheral portion 13a2 of the frame-shaped portion 13a toward the back side. In other words, the collar portion 13b having the short square tube shape is continuous with the outer peripheral edge of the frame-shaped portion 13a at substantially the center, in the axis direction (the Z-axis direction), of the inner peripheral surface of the collar portion 13b, throughout the peripheries of the collar portion 13b. The first collar portion 34 is disposed so as to enclose the respective outer peripheral end surfaces of the touch panel 14 and the cover panel 15, which are disposed on the front side with respect to the frame-shaped portion 13a, throughout the peripheries of the touch panel 14 and the cover panel 15. The first collar portion 34 has its inner peripheral surface opposed to the respective outer peripheral end surfaces of the touch panel 14 and the cover panel 15, whereas the outer peripheral surface of the first collar portion 34 is exposed outside the liquid crystal display device 10, thus forming the exterior view of the liquid crystal display device 10 on the lateral side thereof. On the other hand, the second collar portion 35 surrounds the front side end (attachment portion 16c) of the casing 16, which is disposed on the back side with respect to the frame-shaped portion 13a, from the outer peripheral side. The second collar portion 35 has its inner peripheral surface opposed to the attachment portion 16c of the casing 16, as will be described later, whereas the outer peripheral surface of the second collar portion 35 is exposed outside the liquid crystal display device 10, thus forming the exterior view of the liquid crystal display device 10 on the lateral side. The second collar portion 35 has a frame-side locking nail portion 35a having a hook-shaped cross section which is formed at the protruding tip end thereof. By having the casing 16 locked on the frame-side locking nail portion 35a, the casing 16 can be held in an attached state.

The attachment plate portion 13c, as illustrated in FIG. 3 and FIG. 4, has a plate shape protruding from the outer peripheral portion 13a2 of the frame-shaped portion 13a toward the back side and extending along the side portions of the frame-shaped portion 13a, and has a plate surface substantially orthogonal to the plate surface of the frame-shaped portion 13a. The attachment plate portion 13c is disposed for each of the side portions of the frame-shaped portion 13a. The attachment plate portion 13c disposed at the short-side portion of the frame-shaped portion 13a on the LED board 18 side has its plate surface facing the inner side attached in contact with the outer-side plate surface of the second heat-dissipating portion 23b of the heat-dissipating member 23. The attachment plate portion 13c is screwed to the second heat-dissipating portion 23b by means of a screw member SM, and has a screw insertion hole 13c1 for inserting the screw member SM. The second heat-dissipating portion 23b also has a screw hole 36 formed therein for threadedly engaging the screw member SM. In this way, the heat from the LEDs 17 transmitted from the first heat-dissipating portion 23a to the second heat-dissipating portion 23b is transmitted to the attachment plate portion 13c and then to the whole of the frame 13, so that the heat can be dissipated efficiently. It may also be said that the attachment plate portion 13c is indirectly fixed to the chassis 22 via the heat-dissipating member 23. Meanwhile, the attachment plate portions 13c respectively disposed at the short-side portion on the opposite side of the frame-shaped portion 13a from the LED board 18 side and at the pair of long-side portions are respectively screwed, by means of the screw members SM, such that their plate surfaces facing the inner side are in contact with the outer-side plate surfaces of the respective side plates 22b of the chassis 22. The attachment plate portions 13c have screw insertion holes 13c1 formed therein for inserting the screw members SM, while the side plates 22b have the screw holes 36 formed therein for threadedly engaging the screw members SM. Specifically, a plurality of screw members SM are attached to each of the attachment plate portions 13c, side by side in an intermittent manner along the direction in which the plate portion 13c extends.

The touch panel 14 assembled to the frame 13 will be described. The touch panel 14, as illustrated in FIG. 1, FIG. 3, and FIG. 4, is a position input device for the user to input position information in the plane of the display surface DS of the liquid crystal panel 11. The touch panel 14 has a rectangular shape and includes a substantially transparent glass substrate with an excellent light transmissivity on which a predetermined touch panel pattern (not illustrated) is formed. Specifically, the touch panel 14 has a glass substrate which is rectangular as viewed in plan, similarly to the liquid crystal panel 11, and, on its plate surface facing the front side, there is formed a touch-panel transparent electrode portion (not illustrated) constituting a so-called projection capacitance type touch panel pattern. In the plane of the substrate, a number of touch-panel transparent electrode portions are disposed side by side in a matrix. At one end on the short-side sides of the touch panel 14, there is formed a terminal portion (not illustrated) connected to the end of wiring drawn from the touch-panel transparent electrode portions of the touch panel pattern. To the terminal portion, a flexible board, not illustrated, can be connected, whereby a potential can be supplied from the touch panel drive circuit board to the touch-panel transparent electrode portions forming the touch panel pattern. The touch panel 14, as illustrated in FIG. 5, is fixed in a state in which the inner-side plate surface at the outer peripheral portion of the touch panel 14 is fixed, by means of the first fixing member 30 described above, so as to be opposed to the inner peripheral portion 13a1 of the frame-shaped portion 13a of the frame 13.

The cover panel 15 assembled to the frame 13 will be described. The cover panel 15, as illustrated in FIG. 1, FIG. 3, and FIG. 4, is disposed so as to cover the touch panel 14 entirely from the front side, thereby protecting the touch panel 14 and the liquid crystal panel 11. The cover panel 15 covers the frame-shaped portion 13a of the frame 13 entirely from the front side, and forms the exterior view of the liquid crystal display device 10 on the front surface side. The cover panel 15 has a rectangular shape as viewed in plan, and includes a substantially transparent, sheet base member of glass with excellent light transmissivity, preferably strengthened glass. A preferable example of the strengthened glass used for the cover panel 15 is a chemically strengthened glass including a sheet glass base member with a chemically strengthened layer provided on a surface thereof by chemical strengthening process. The chemical strengthening process herein refers to, for example, a process of strengthening the sheet glass base member by substituting, through ion exchange, alkaline metal ions included in the glass material with alkaline metal ions having a greater ion radius, wherein the resultant chemically strengthened layer provides a compressive stress layer (ion exchange layer) in which compressive stress remains. In this way, the mechanical strength and shock resistance performance of the cover panel 15 are increased, so that the touch panel 14 and the liquid crystal panel 11 disposed on the back side of the cover panel 15 can be more reliably prevented from being damaged or scratched.

The cover panel 15, as illustrated in FIG. 3 and FIG. 4, has a rectangular shape as viewed in plan, similar to the liquid crystal panel 11 and the touch panel 14, and has a size as viewed in plan which is slightly larger than the liquid crystal panel 11 and the touch panel 14. Accordingly, the cover panel 15 has extended portions 15EP extending outward from the respective outer peripheral edges of the liquid crystal panel 11 and the touch panel 14, throughout the peripheries thereof like eaves. The extended portions 15EP have a rectangular, substantially frame-like (substantially picture frame-like) shape enclosing the liquid crystal panel 11 and the touch panel 14, and, as illustrated in FIG. 5, have the plate surface on the inner side thereof fixed in a state of being opposed to the outer peripheral portion 13a2 of the frame-shaped portion 13a of the frame 13 via the second fixing member 31. Meanwhile, the center portion of the cover panel 15 opposed to the touch panel 14 is layered on the front side of the touch panel 14 via the antireflection film AR.

On the plate surface (plate surface facing the touch panel 14) on the inner side (back side) of the outer peripheral portion of the cover panel 15 including the extended portions 15EP, as illustrated in FIG. 3 and FIG. 4, there is formed a plate surface light-blocking layer (light-blocking layer, plate surface light-blocking portion) 32 that blocks light. The plate surface light-blocking layer 32 includes a light-blocking material, such as black paint, for example, where the light-blocking material may be integrally provided on the inner-side plate surface of the cover panel 15 by being printed on the plate surface. When the plate surface light-blocking layer 32 is provided, various printing means may be adopted, such as screen printing or ink jet printing, for example. The plate surface light-blocking layer 32 is formed, in addition to the entire regions of the extended portions 15EP of the cover panel 15, in a range covering portions on the inside of the extended portions 15EP and overlapping the respective outer peripheral portions of the touch panel 14 and the liquid crystal panel 11 as viewed in plan. Accordingly, the plate surface light-blocking layer 32 is disposed in such a manner as to enclose the display area of the liquid crystal panel 11, and can therefore block light outside the display area, whereby the display quality of the image displayed in the display area can be enhanced.

The casing 16 assembled to the frame 13 will be described. The casing 16 is made of synthetic resin material or metal material, and, as illustrated in FIG. 1, FIG. 3, and FIG. 4, has a substantially saucer-like (substantially bowl-like) shape with an opening toward the front side. The casing 16 covers members such as the frame-shaped portion 13a and the attachment plate portion 13c of the frame 13, the chassis 22, and the heat-dissipating member 23 from the back side, while forming the exterior view of the liquid crystal display device 10 on the rear surface side. The casing 16 includes an almost flat bottom portion 16a; a curbed portion 16b rising from the outer peripheral edge of the bottom portion 16a toward the front side and having a curve shaped cross section; and an attachment portion 16c rising substantially straight from the outer peripheral edge of the curbed portion 16b toward the front side. The attachment portion 16c has a casing-side locking nail portion 16d having a hook-shaped cross section. As the casing-side locking nail portion 16d is locked on the frame-side locking nail portion 35a of frame 13, the casing 16 can be held in an attached state with respect to the frame 13.

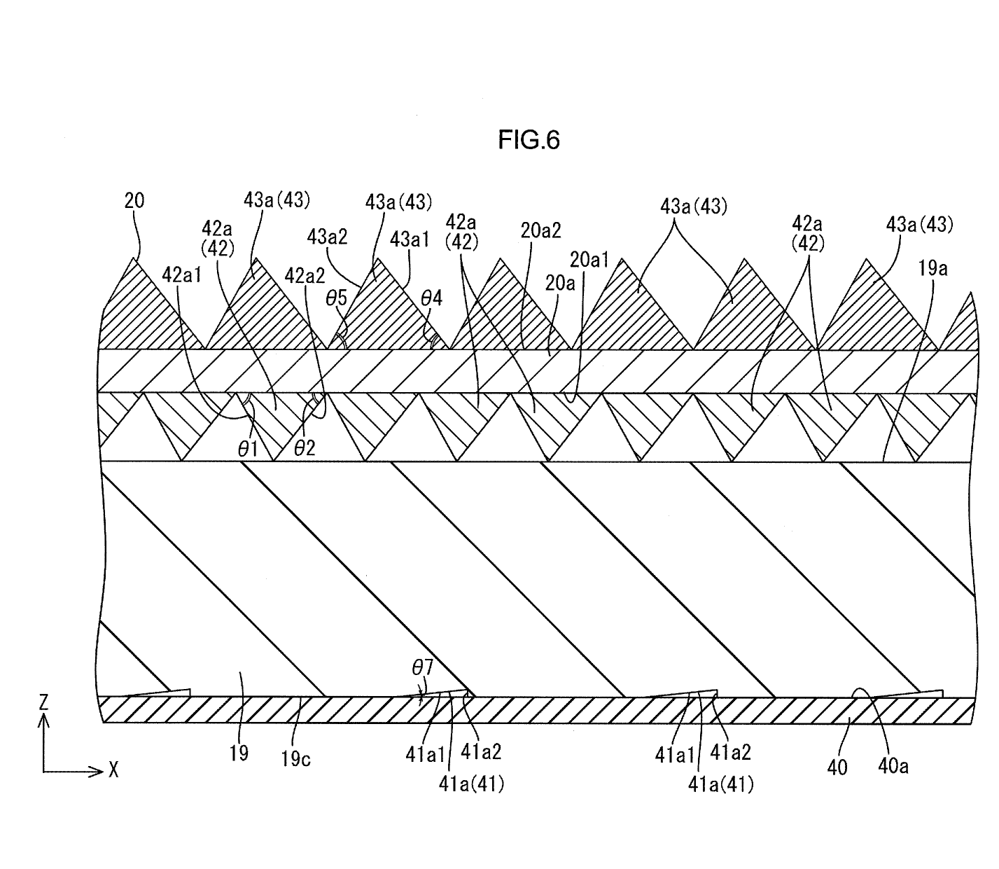

The prism sheet 20 will be once again described in detail. The prism sheet 20 is provided with prism portions 42 on the rear surface and prism portions 43 on the front surface, efficiently providing the light with a light condensing effect. The prism sheet 20, as illustrated in FIG. 2 and FIG. 6, includes: a film of base member 20a; a light input-side prism portion 42 formed on a light input-side plate surface 20a1 of the base member 20a on which light from the light guide plate 19 becomes incident; and a light output-side prism portion 43 formed on a light output-side plate surface 20a2 of the base member 20a from which light is emitted toward the liquid crystal panel 11. The prism sheet 20 is made of a synthetic resin having excellent light transmissivity, such as polymethylmethacrylate (PMMA), polycarbonate (PC), or triacetylcellulose (TAC). The prism sheet 20 has a refractive index value in the range of 1.49 to 1.585. Accordingly, while the critical angle of the prism sheet 20 is in the angle range of 39.12° to 42.16°, the prism sheet 20 has the Brewster's angle in the angle range of 32.2° to 33.9°. Because the base member 20a includes an unstretched film that is not stretched during the manufacturing process, disturbance in the polarization of light when the light passes through the base member 20a is prevented.

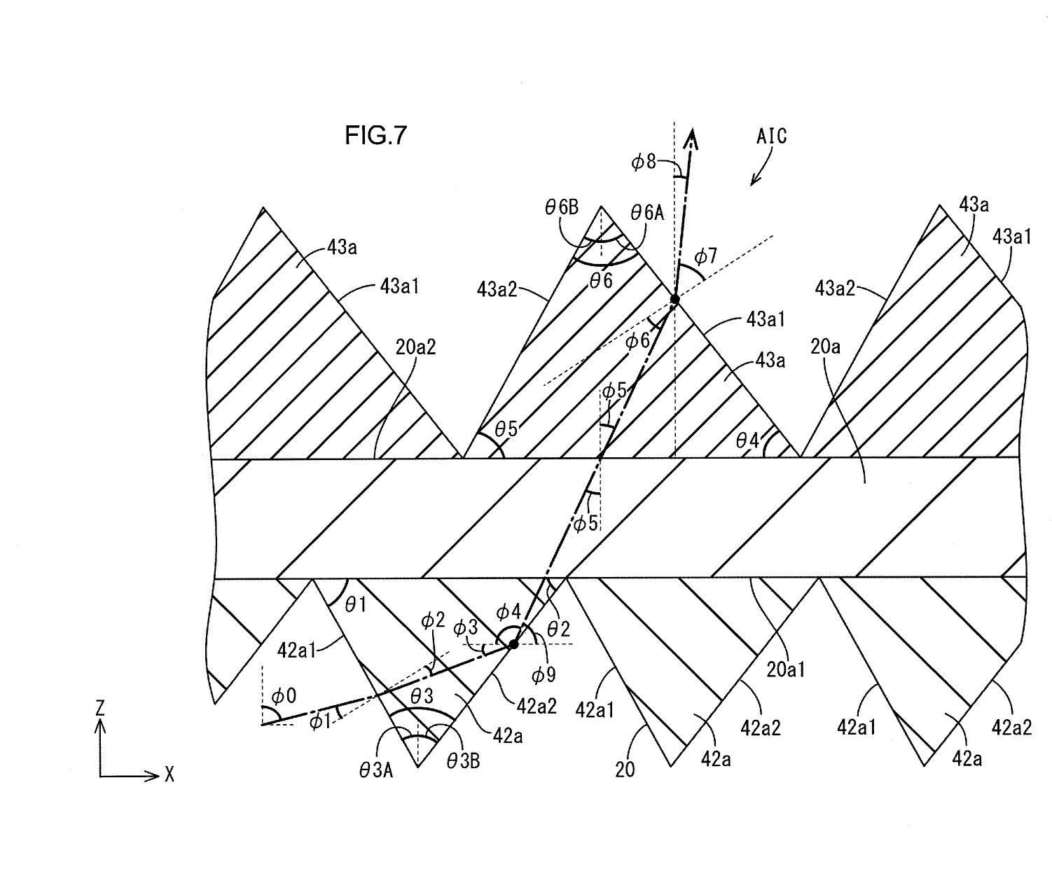

The light input-side prism portion 42, as illustrated in FIG. 2 and FIG. 6, is integrally provided on the light input-side plate surface 20a1, which is the back-side plate surface of the base member 20a opposed to the light emission surface 19a of the light guide plate 19, and on which the light emitted from the light emission surface 19a becomes incident. The light input-side prism portion 42 includes multiple light input-side unit prisms 42a protruding from the light input-side plate surface 20a1 of the base member 20a toward the back side (light guide plate 19 side) along the Z-axis direction. The light input-side unit prisms 42a have a substantially triangular (substantially mountain-shaped) cross section taken along the X-axis direction while extending linearly along the Y-axis direction. A number of the light input-side unit prisms 42a are disposed on the light input-side plate surface 20a1 side by side along the X-axis direction. That is, a number of the light input-side unit prisms 42a extend in parallel with the light incident surface 19b of the light guide plate 19, and are disposed side by side along a direction orthogonal to the extending direction. Each of the light input-side unit prisms 42a, as illustrated in FIG. 6 and FIG. 7, has a pair of light input-side inclined surfaces 42a1 and 42a2 across the apex portion. Each of the pair of light input-side inclined surfaces 42a1 and 42a2 is inclined with respect to the plate surface (light input-side plate surface 20a1; the X-axis direction) of the base member 20a. Of the pair of light input-side inclined surfaces 42a1 and 42a2, the one disposed on the light incident surface 19b side with respect to the apex portion (on the left side in FIG. 6 and FIG. 7) is the first light input-side inclined surface 42a1, while the one disposed on the non-light input opposite surface 19d side with respect to the apex portion (on the right side in FIG. 6 and FIG. 7) is the second light input-side inclined surface 42a2. The second light input-side inclined surface 42a2 has an inclination angle θ2 with respect to the plate surface of the base member 20a which is relatively small compared with a corresponding inclination angle θ1 of the first light input-side inclined surface 42a1. Accordingly, the second light input-side inclined surface 42a2 has an extending surface distance from the bottom portion to the apex portion which is greater than the extending surface distance of the first light input-side inclined surface 42a1 from the bottom portion to the apex portion. The light input-side unit prisms 42a extend along the X-axis direction while the pair of light input-side inclined surfaces 42a1 and 42a2 maintain constant inclination angles θ1 and θ2, so that the inclination angles θ1 and θ2 of the light input-side inclined surfaces 42a1 and 42a2 do not change at any position along the X-axis direction. In the multiple light input-side unit prisms 42a disposed along the X-axis direction, the light input-side inclined surfaces 42a1 and 42a2 have substantially the same inclination angles θ1 and θ2, apex angle θ3, and bottom-side width dimension and height dimension, and the adjacent light input-side unit prisms 42a are also disposed at substantially constant and equal intervals.

The light output-side prism portion 43, as illustrated in FIG. 2 and FIG. 6, is disposed on the front-side plate surface of the base member 20a and integrally provided on the light output-side plate surface 20a2 which is opposed to the polarizing plate 11d on the back side of the liquid crystal panel 11, and from which light is emitted toward the polarizing plate 11d. The light output-side prism portion 43 includes multiple light output-side unit prisms 43a protruding from the light output-side plate surface 20a2 of the base member 20a toward the front side (liquid crystal panel 11 side) along the Z-axis direction. The light output-side unit prisms 43a have a substantially triangular (substantially mountain-shaped) cross section taken along the X-axis direction, and linearly extend along the Y-axis direction. A number of the light output-side unit prisms 43a are disposed side by side along the X-axis direction on the light output-side plate surface 20a2. That is, a number of the light output-side unit prisms 43a extend in parallel with the light incident surface 19b of the light guide plate 19 and disposed side by side along a direction orthogonal to the extending direction. Each of the light output-side unit prisms 43a, as illustrated in FIG. 6 and FIG. 7, includes a pair of light output-side inclined surfaces 43a1 and 43a2 across the apex portion. Each of the pair of light output-side inclined surfaces 43a1 and 43a2 is inclined with respect to the plate surface of the base member 20a (light output-side plate surface 20a2; the X-axis direction). Of the pair of light output-side inclined surfaces 43a1 and 43a2, the one disposed on the non-light input opposite surface 19d side (the right side in FIG. 6 and FIG. 7) with respect to the apex portion is the first light output-side inclined surface 43a1, while the one disposed on the light incident surface 19b side (the left side in FIG. 6 and FIG. 7) with respect to the apex portion is the second light output-side inclined surface 43a2. The first light output-side inclined surface 43a1 has an inclination angle θ4 with respect to the plate surface of the base member 20a which is relatively small compared with a corresponding inclination angle of the second light output-side inclined surface 43a2. Accordingly, the first light output-side inclined surface 43a1 has an extending surface distance from the bottom portion to the apex portion which is greater than the extending surface distance of the second light output-side inclined surface 43a2 from the bottom portion to the apex portion. Because the light output-side unit prisms 43a extend along the X-axis direction while the pair of light output-side inclined surfaces 43a1 and 43a2 maintain constant inclination angles θ4 and θ5, the inclination angles θ4 and θ5 of the light output-side inclined surfaces 43a1 and 43a2 do not change at any position with respect to the X-axis direction. The light output-side unit prisms 43a have bottom-side width dimension and height dimension which are relatively large compared with the bottom-side width dimension and height dimension of the light input-side unit prisms 42a. In the multiple light output-side unit prisms 43a disposed along the X-axis direction, the respective light output-side inclined surfaces 43a1 and 43a2 have substantially the same inclination angles θ4 and θ5, apex angle θ6, and bottom-side width dimension and height dimension. The adjacent light output-side unit prisms 43a are also disposed at substantially constant and equal intervals.

When the prism sheet 20 configured as described above is supplied with light from the light guide plate 19, the following effects are obtained. That is, because the output light from the light guide plate 19 includes a component that travels from the light incident surface 19b side toward the non-light input opposite surface 19d side with regard to the first direction, the light initially becomes incident on the first light input-side inclined surface 42a1 of the light input-side unit prisms 42a which is disposed on the light incident surface 19b side with respect to the apex portion. The light incident on the first light input-side inclined surface 42a1 is refracted at an angle based on the inclination angle θ1 of the first light input-side inclined surface 42a1. The light that passes through the light input-side unit prisms 42a is totally reflected by the second light input-side inclined surface 42a2 of the light input-side unit prisms 42a which is disposed on the non-light input opposite surface 19d side with respect to the apex portion. Accordingly, the light is angled based on the inclination angle θ2 of the second light input-side inclined surface 42a2, and travels toward the base member 20a and the light output-side unit prisms 43a. The light that has passed through the base member 20a and the light output-side unit prisms 43a, when emitted from the first light output-side inclined surface 43a1 of the light output-side unit prisms 43a which is disposed on the non-light input opposite surface 19d side with respect to the apex portion, is refracted at an angle based on the inclination angle θ4 of the first light output-side inclined surface 43a1. Accordingly, the light is angled such that its travel direction approaches the normal direction to the plate surface of the base member 20a (frontal direction).

The light input-side unit prisms 42a constituting the light input-side prism portion 42, and the light output-side unit prisms 43a constituting the light output-side prism portion 43 have an incidence angle control structure AIC for controlling light incidence angle with respect to the first light output-side inclined surface 43a1. In the incidence angle control structure AIC, as illustrated in FIG. 7, the inclination angles θ1, θ2, and θ4 of the first light output-side inclined surface 43a1, the first light input-side inclined surface 42a1, and the second light input-side inclined surface 42a2 are set such that the light incidence angle with respect to the first light output-side inclined surface 43a1 is in an angle range including the Brewster's angle. The Brewster's angle is an incidence angle such that the reflectance of P-polarization component included in the light becomes zero.

The incidence angle control structure AIC provides the following operation and effect. That is, the light having been passed through the light output-side unit prisms 43a and travelling toward the first light output-side inclined surface 43a1, as illustrated in FIG. 7, has an incidence angle with respect to the first light output-side inclined surface 43a1 in an angle range including the Brewster's angle. Accordingly, with respect to the P-polarization component of the light travelling toward the first light output-side inclined surface 43a1, there is hardly any attenuation by being reflected by the first light output-side inclined surface 43a1, so that the light is emitted from the first light output-side inclined surface 43a1 with high efficiency. In addition, the light supplied to the light output-side unit prisms 43a is angled in advance based on the inclination angles θ1 and θ2 respectively of the first light input-side inclined surface 42a1 and the second light input-side inclined surface 42a2 of the light input-side unit prisms 42a. Accordingly, compared with a conventional configuration not provided with a light input-side unit prism, attenuation of P-polarization component can be suppressed appropriately in accordance with the output angle of the output light from the light guide plate 19. The light incidence plane with respect to the unit prisms 42a and 43a is parallel with the X-axis direction and the Z-axis direction, and is also parallel with the polarization direction of the polarizing plate 11d on the back side of the liquid crystal panel 11. Accordingly, the P-polarization component of the incident light with respect to the first light output-side inclined surface 43a1, as it is emitted from the first light output-side inclined surface 43a1, is transmitted through the back-side polarizing plate 11d with hardly any loss. In this way, high light utilization efficiency is achieved.

Specifically, the inclination angle θ1 of the first light input-side inclined surface 42a1 is preferably in an angle range of 50° to 80°, whereas the inclination angle θ2 of the second light input-side inclined surface 42a2 is preferably in an angle range of 36° to 49°. The apex angle θ3 (θ3A+θ3B) of the light input-side unit prisms 42a is preferably in an angle range of 51° to 94°. Meanwhile, the inclination angle θ4 of the first light output-side inclined surface 43a1 is in an angle range of 46° to 61°. When the inclination angles θ1, θ2, and θ4 of the respective inclined surfaces 42a1, 42a2, and 43a1 are set as described above, the light incidence angle with respect to the first light output-side inclined surface 43a1 is within the angle range of 28° to 37° including the Brewster's angle (32.2° to 33.9°) in the prism sheet 20 of which the refractive index is in the range of 1.49 to 1.585. In this way, the reflectance of the P-polarization component of light in the first light output-side inclined surface 43a1 becomes extremely small at not more than 1%, whereby high light utilization efficiency can be achieved.

With reference to more specific angle ranges of the inclination angles θ1, θ2, and θ4 of the respective inclined surfaces 42a1, 42a2, and 43a1, when the refractive index of the prism sheet 20 is 1.585, for example, the inclination angle θ1 of the first light input-side inclined surface 42a1 is preferably in an angle range of 50° to 80°; the inclination angle θ2 of the second light input-side inclined surface 42a2 is preferably in an angle range of 36° to 48°; and the inclination angle θ4 of the first light output-side inclined surface 43a1 is preferably in an angle range of 50° to 60°. In this way, the light incidence angle with respect to the first light output-side inclined surface 43a1 is in the angle range of 28° to 34.5° including the Brewster's angle (32.2°) in the prism sheet 20 having the refractive index of 1.585, whereby the reflectance of the P-polarization component of light on the first light output-side inclined surface 43a1 becomes not more than 1%. In other cases, when the refractive index of the prism sheet 20 is 1.49, for example, the inclination angle θ1 of the first light input-side inclined surface 42a1 is preferably in an angle range of 50° to 80°; the inclination angle θ2 of the second light input-side inclined surface 42a2 is preferably in an angle range of 37° to 49°; and the inclination angle θ4 of the first light output-side inclined surface 43a1 is preferably in an angle range of 46° to 61°. In this way, the light incidence angle with respect to the first light output-side inclined surface 43a1 will be in an angle range of 28° to 37° including the Brewster's angle (33.9°) in the prism sheet 20 of which the refractive index is 1.49, whereby the reflectance of the P-polarization component of light in the first light output-side inclined surface 43a1 becomes not more than 1%.

Further, the inclination angle θ5 of the second light output-side inclined surface 43a2 is preferably in an angle range of 65° to 80°. The inclination angle θ5 of the second light output-side inclined surface 43a2 is relatively larger than an angle φ9 at which the light totally reflected by the second light input-side inclined surface 42a2 has a minor angle with respect to the plate surface of the base member 20a. Accordingly, the light totally reflected by the second light input-side inclined surface 42a2 is prevented from directly hitting the second light output-side inclined surface 43a2. In this way, the generation of reflected light due to the second light output-side inclined surface 43a2 or transmitted light due to the second light output-side inclined surface 43a2 can be prevented, whereby the output light from the prism sheet 20 can be made uniform. The apex angle θ6 (θ6A+θ6B) of the light output-side unit prisms 43a is preferably in an angle range of 39° to 69°. The apex angle θ6 of the light output-side unit prisms 43a is an acute angle.

Next, the output light reflective prism portion 41 will be described in detail. The output light reflective prism portion 41 is used for emitting light from the light emission surface 19a of the light guide plate 19 that supplies light to the prism sheet 20 equipped with the incidence angle control structure AIC. The unit reflective prisms 41a of the output light reflective prism portion 41, as illustrated in FIG. 6, includes an output light reflective inclined surface 41a1. The output light reflective inclined surface 41a1 has an inclination angle θ7 with respect to the opposing plate surface 19c which is smaller than a numerical value obtained by subtracting from 45° the critical angle (38.97°) of the light guide plate 19. Specifically, the inclination angle θ7 of the output light reflective inclined surface 41a1 is preferably not greater than 6.03° and more preferably in an angle range of 0.5° to 3°. When the inclination angle θ7 of the output light reflective inclined surface 41a1 has such values, the light that has propagated through the light guide plate 19 and been totally reflected by the light emission surface 19a is totally reflected without fail by the output light reflective inclined surface 41a1 of the unit reflective prisms 41a, and the light travels toward the light emission surface 19a. The reason will be described in the following. The light incidence angle with respect to the output light reflective inclined surface 41a1 of the unit reflective prisms 41a is obtained by subtracting, from the reflected angle by the light emission surface 19a (having the same value as the incidence angle on the light emission surface 19a), the inclination angle θ7 of the output light reflective inclined surface 41a1. Because the minimum value of the reflected angle by the light emission surface 19a is the value obtained by subtracting from 90° the critical angle (38.97°) of the light guide plate 19, the light incidence angle with respect to the output light reflective inclined surface 41a1 exceeds the critical angle without fail. Accordingly, no light is produced that passes through the output light reflective inclined surface 41a1, whereby the travel direction of the light travelling toward the light emission surface 19a is made uniform.

When the inclination angle θ7 of the output light reflective inclined surface 41a1 has the above values, the light that is totally reflected by the output light reflective inclined surface 41a1 and that travels toward the light emission surface 19a includes, in addition to the light emitted from the light emission surface 19a as is, the light totally reflected by the light emission surface 19a again. The reason is as follows. The light totally reflected by the output light reflective inclined surface 41a1 has an incidence angle with respect to the light emission surface 19a which is obtained by subtracting, from the reflected angle by the light emission surface 19a (having the same value as the incidence angle on the light emission surface 19a), twice the value of the inclination angle θ7 of the output light reflective inclined surface 41a1. Because the minimum value of the reflected angle by the light emission surface 19a is obtained by subtracting from 90° the critical angle (38.97°) of the light guide plate 19, the light incidence angle with respect to the light emission surface 19a does not necessarily exceed the critical angle and may not exceed the critical angle. The light totally reflected by the light emission surface 19a again is totally reflected by the output light reflective inclined surface 41a1 of the next and subsequent unit reflective prisms 41a, and is eventually emitted from the light emission surface 19a. That is, the output light from the light emission surface 19a includes to no small extent light that has been totally reflected a plurality of times by the output light reflective inclined surface 41a1, and such output light has the incidence angles with respect to the light emission surface 19a aligned close to the critical angle (slightly greater than the critical angle). Accordingly, the output angles of the output light from the light emission surface 19a are aligned in an angle range of 70° to 80°, for example, so that the incidence angles of the light that travels from the light guide plate 19 toward the prism sheet 20 and becomes incident on the light input-side unit prisms 42a are made uniform. Thus, the light can be efficiently provided with a light condensing effect by means of the prism sheet 20.

The grounds for setting the respective inclination angles θ1, θ2, and θ4 of the inclined surfaces 42a1, 42a2, and 43a1 of the incidence angle control structure AIC as described above will be described. In the description, as illustrated in FIG. 7, the output angle of the output light from the light guide plate 19 is φ0; the light incidence angle with respect to the first light input-side inclined surface 42a1 is φ1; the refractive angle of the light refracted by the first light input-side inclined surface 42a1 is φ2; the angle of the light incident on the second light input-side inclined surface 42a2 with respect to the plate surface of the base member 20a (first direction) is φ3; the angle at which the light totally reflected by the second light input-side inclined surface 42a2 has a reflex angle with respect to the plate surface of the base member 20a is φ4; the incidence angle and output angle of light with respect to the bottom surface (the light input-side plate surface 20a1 of the base member 20a) of the light output-side unit prisms 43a are φ5; the incidence angle of light with respect to the first light output-side inclined surface 43a1 is φ6; the refractive angle of light refracted by the first light output-side inclined surface 43a1 is φ7; and the angle of the output light from the first light output-side inclined surface 43a1 with respect to the normal direction to the plate surface of the base member 20a is φ8. The angle at which the light totally reflected by the second light input-side inclined surface 42a2 has a minor angle with respect to the plate surface of the base member 20a is φ9. The refractive index of the prism sheet 20 is n1. The inclination angles θ1, θ2, θ4, and θ5 of the respective inclined surfaces 42a1, 42a2, 43a1, and 43a2 of the light input-side unit prisms 42a and the light output-side unit prisms 43a are as described above. The apex angle θ3 of the light input-side unit prisms 42a includes an angle θ3A of the first light input-side inclined surface 42a1 with respect to the normal direction to the base member 20a, and an angle θ3B of the second light input-side inclined surface 42a2 with respect to the normal direction to the base member 20a. Similarly, the apex angle θ6 of the light output-side unit prisms 43a includes an angle θ6A of the first light output-side inclined surface 43a1 with respect to the normal direction to the base member 20a, and an angle θ6B of the second light output-side inclined surface 43a2 with respect to the normal direction to the base member 20a.

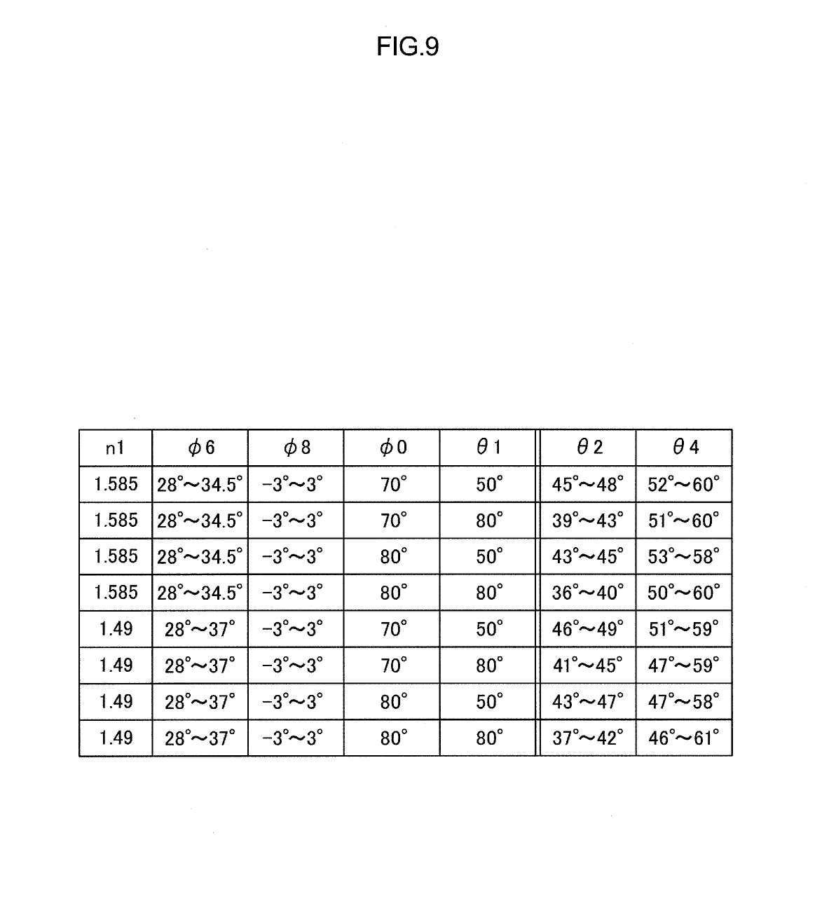

Based on the above-described premise, φ1 to φ8 are respectively expressed by φ1=φ0−φ1; φ2=Arcsin(sin φ1/n1); φ3=90°−(θ1+φ2); φ4=φ3+2×θ3B=φ3+180°−2×θ2; φ5=φ4−90°=90°−φ6−θ6A; φ6=90°−(φ5+θ6A); φ7=Arcsin(sin φ1×n1); φ8=90°−(φ7+θ6A); and φ9=180°−φ4=90°−φ5. Also, θ2, θ3B, and θ4 are respectively expressed by θ2=90°−θ3B=(180°+φ3−φ4)/2; θ3B=φ4/2; and θ4=90°−θ6A. When initial conditions n1=1.49 to 1.585, φ0=70° to 80°, θ1 =50° to 80°, φ6=28° to 37°, and φ8=−3° to 3° are given, the above expressions can be used to calculate θ2=36° to 49°, and θ4=46° to 61° (see FIG. 9). Of the initial conditions, the angle range of φ6 includes the Brewster's angle (32.2° to 33.9°), and is a condition such that the reflectance of the P-polarization component of the incident light with respect to the first light output-side inclined surface 43a1 becomes not more than 1%. Of the initial conditions, the angle range of φ0 presumes that the light with respect to the light emission surface 19a of the light guide plate 19 includes much light of which the incidence angle is slightly greater than the critical angle. This is based on the above-described design of the inclination angle θ7 of the output light reflective inclined surface 41a1 of the unit reflective prisms 41a of the output light reflective prism portion 41 (the design in which the inclination angle θ7 becomes smaller than the numerical value obtained by subtracting from 45° the critical angle of the light guide plate 19). In addition, of the initial conditions, the angle range of φ8 is set such that the travel direction of the output light from the prism sheet 20 is close to the frontal direction (the normal direction to the plate surface of the base member 20a) and such that sufficiently high front brightness can be obtained.

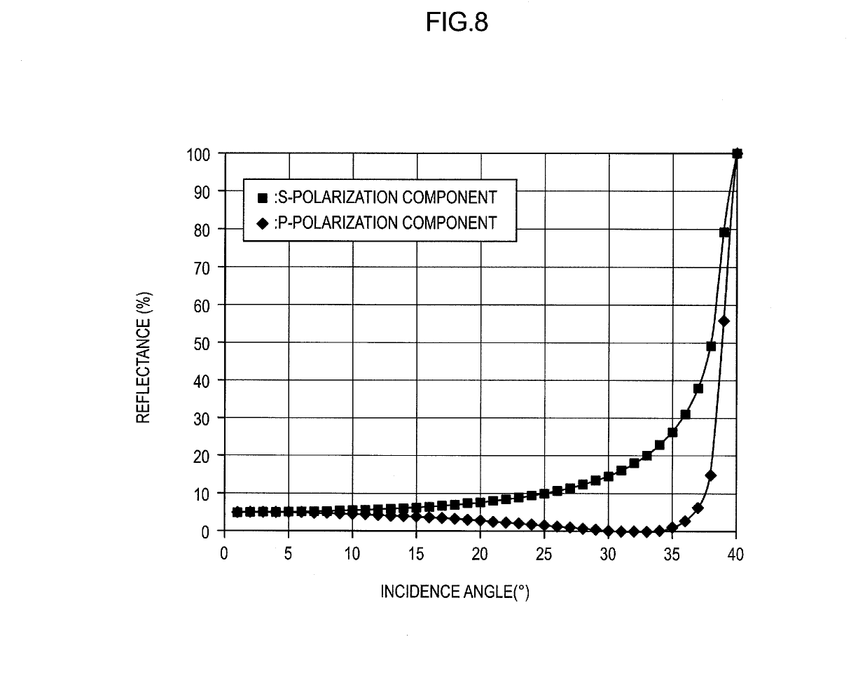

More specifically, FIG. 9 illustrates the results of calculating the inclination angle θ2 of the second light input-side inclined surface 42a2 and the inclination angle θ4 of the first light output-side inclined surface 43a1 when values of n1, φ0, θ1, φ6, and φ8 were given as initial conditions. As illustrated in FIG. 9, when the initial conditions n1=1.585, φ0=70° to 80°, θ1=50° to 80°, φ6=28° to 34.5°, and φ8=−3° to 3° are given, the above expressions can be used to calculate θ2=36° to 48° and θ4=50° to 60°. The angle range of φ6 includes the Brewster's angle (32.2°) and is a condition such that the reflectance of the P-polarization component of incident light with respect to the first light output-side inclined surface 43a1 becomes not more than 1%. The grounds for this will be described with reference to FIG. 8. FIG. 8 illustrates a relationship between the light incidence angle (in units of degrees (“°”)) and the reflectance of S-polarization component and the reflectance of P-polarization component (respectively in units of percentages (“%”)) in the prism sheet 20 having a refractive index of 1.585. According to FIG. 8, the reflectance of P-polarization component gradually decreases as the light incidence angle is increased from 0°. When the light incidence angle becomes the Brewster's angle of 32.2°, the reflectance becomes 0% and then increases. When the light incidence angle becomes 40°, the reflectance becomes 100%. It can be seen that, in the angle range of 28° to 34.5° with the Brewster's angle of 32.2° in the middle, the reflectance of P-polarization component is not more than 1%. On the other hand, the reflectance of S-polarization component consistently tends to gradually increase as the light incidence angle is increased from 0°; when the light incidence angle is 40°, the reflectance becomes 100%. Thus, in most of the angle ranges, the reflectance is greater than the reflectance of P-polarization component. When, separately from the above, the initial conditions n1=1.49, φ0=70° to 80°, θ1=50° to 80°, φ6=28° to 37°, and φ8=−3° to 3° are given, the above expressions can be used to calculate θ2=37° to 49° and θ4=46° to 61°. The angle range of φ6 includes the Brewster's angle (33.9°) and is a condition such that the reflectance of the P-polarization component of incident light with respect to the first light output-side inclined surface 43a1 becomes not more than 1%.

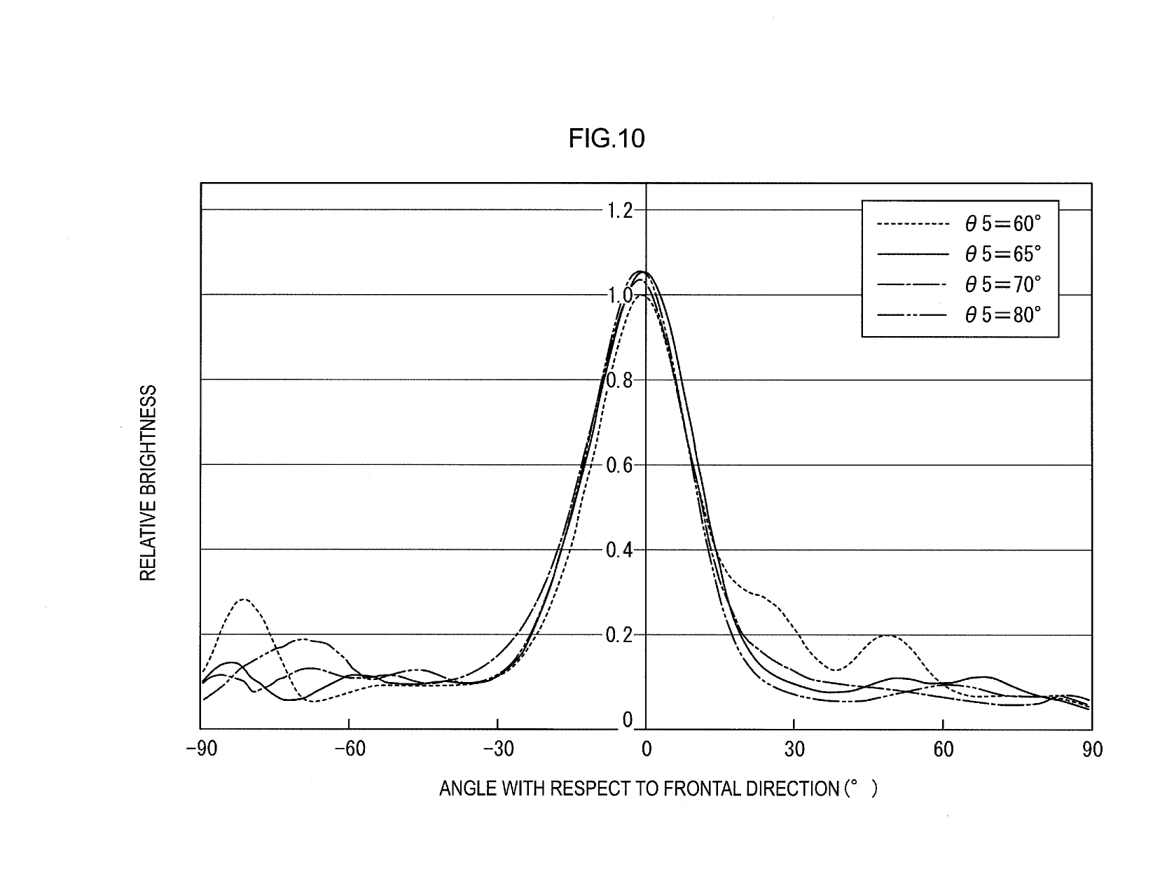

Next, the grounds for setting the inclination angle θ5 of the second light output-side inclined surface 43a2 of the light output-side unit prisms 43a in the angle range of 65° to 80° will be discussed with reference to FIG. 10. FIG. 10 shows the brightness angle distribution related to the output light from the prism sheet 20 against changes in the inclination angle θ5 of the second light output-side inclined surface 43a2. Specifically, FIG. 10 shows the brightness angle distribution related to the output light from the prism sheet 20 in cases where the inclination angle θ5 of the second light output-side inclined surface 43a2 is 60°, 65°, 70°, and 80°. In FIG. 10, the vertical axis shows the relative brightness (no unit) of the output light from the prism sheet 20, and the horizontal axis shows the angle (in units of degrees (“°”)) with respect to the frontal direction. In FIG. 10, the relative brightness on the vertical axis indicates relative values relative to the brightness value (1.0) for the frontal direction (angle 0°) when the inclination angle θ5 of the second light output-side inclined surface 43a2 is 60°. It can be seen from FIG. 10 that, when the inclination angle θ5 of the second light output-side inclined surface 43a2 is 65°, 70°, and 80°, the output light from the prism sheet 20 includes much light that travels along the frontal direction (the light having an angle of 0° with respect to the frontal direction), and not much light that travels along directions that are greatly inclined with respect to the frontal direction. On the other hand, when the inclination angle θ5 of the second light output-side inclined surface 43a2 is 60°, the output light from the prism sheet 20 includes a relatively small amount of light that travels along the frontal direction, and a relatively large amount of light that travels along directions that are greatly inclined with respect to the frontal direction. Specifically, when the inclination angle θ5 of the second light output-side inclined surface 43a2 is 60°, the output light from the prism sheet 20 includes much light having angles in an angle range of −60° to −90° or an angle range of 20° to 60° with respect to the frontal direction, i.e., sidelobe light, so that the front brightness of the output light, i.e., the light condensing performance of the prism sheet 20 is relatively decreased. Such result is obtained because, when the inclination angle θ5 of the second light output-side inclined surface 43a2 is 60°, the numerical value becomes smaller than the angle φ9 at which the angle of the light totally reflected by the second light input-side inclined surface 42a2 of the light input-side unit prisms 42a becomes a minor angle with respect to the plate surface of the base member 20a. At such angle setting, the light totally reflected by the second light input-side inclined surface 42a2 directly hits the second light output-side inclined surface 43a2 of the light output-side unit prisms 43a, causing reflected light due to the second light output-side inclined surface 43a2 or transmitted light due to the second light output-side inclined surface 43a2. Such light may become sidelobe light traveling along directions greatly inclined with respect to the frontal direction, thereby decreasing the front brightness. Such being the case, the inclination angle θ5 of the second light output-side inclined surface 43a2 is set in the angle range of 65° to 80° which are greater than the angle φ9 at which the light totally reflected by the second light input-side inclined surface 42a2 of the light input-side unit prisms 42a has a minor angle with respect to the plate surface of the base member 20a. In this way, the light totally reflected by the second light input-side inclined surface 42a2 can be prevented from directly hitting the second light output-side inclined surface 43a2 of the light output-side unit prisms 43a, whereby high light utilization efficiency and front brightness can be achieved.

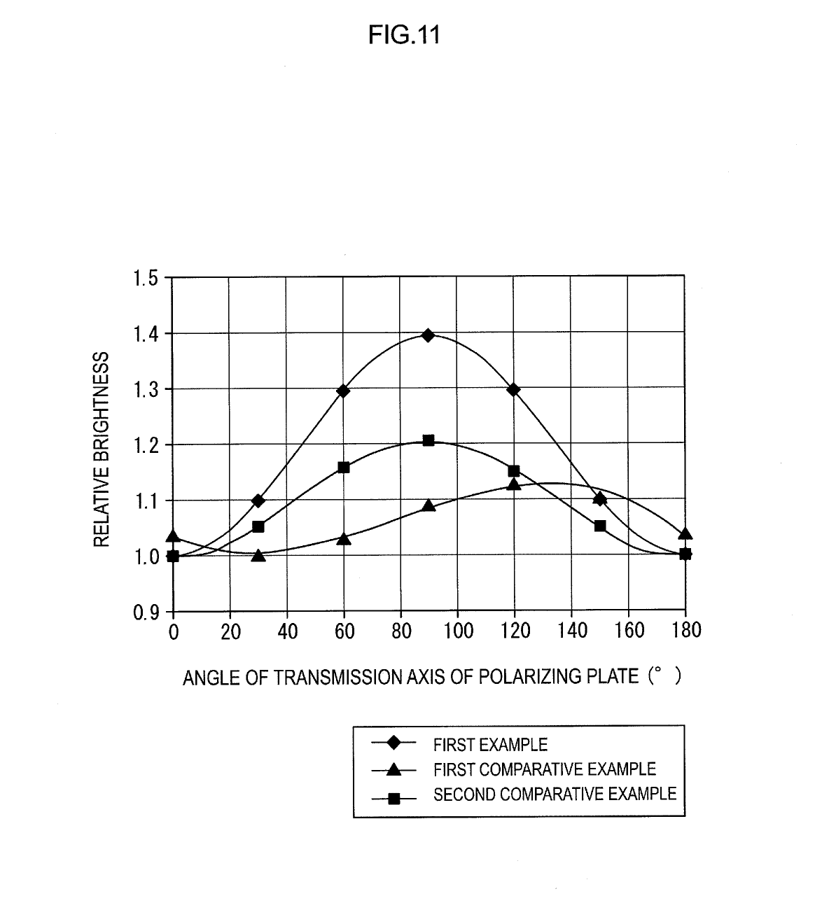

Comparative Experiment 1 was performed to obtain knowledge about how the transmission axis angle dependency of brightness and the polarization degree vary between the prism sheet 20 having the prism portions 42 and 43 on both front and rear sides of the prism sheet, as described above, and a prism sheet having a prism portion only on the back side thereof. In Comparative Experiment 1, there were used: a prism sheet, as Comparative Example 1, including a prism portion provided on a light input-side plate surface (light guide plate-side plate surface) of a base member manufactured by a biaxial stretching method; a prism sheet, as Comparative Example 2, including a prism portion provided on a light input-side plate surface (light guide plate-side plate surface) of a base member including an unstretched film; and the prism sheet 20, as Example 1, including the light input-side prism portion 42 provided on the light input-side plate surface 20a1 and the light output-side prism portion 43 provided on the light output-side plate surface 20a2 of the base member 20a including unstretched film. The prism sheet 20 according to Example 1 is the same one described in the preceding paragraphs. The prism portions of the prism sheets according to Comparative Examples 1 and 2 had the same configuration as the light input-side prism portion 42 described in the preceding paragraphs. The base member of the prism sheet according to Comparative Example 2 had the same configuration as the base member 20a described in the preceding paragraphs. In Comparative Experiment 1, light from the light guide plate 19 was passed through the prism sheets according to Comparative Examples 1 and 2 and Example 1, the transmitted light was passed through the polarizing plate, and the brightness of the resultant output light was measured. Further, the brightness of the output light was measured at different transmission axis angles of the polarizing plate. Specifically, the setting was such that when the transmission axis of the polarizing plate was 90°, the transmission axis of the polarizing plate and the light incidence plane with respect to the prism sheet, i.e., the P-polarization component (first direction), were parallel; and when the transmission axis of the polarizing plate was 0° or 180°, the transmission axis of the polarizing plate and the S-polarization component (second direction) were parallel. In Comparative Experiment 1, the brightness of the output light was measured while the polarizing plate was rotated such that the transmission axis reached from 0° to 180°. The measurement results are shown in FIG. 11. In FIG. 11, the vertical axis shows the relative brightness (no unit) relative to the minimum brightness value (1.0) in Comparative Examples 1 and 2 and Example 1, and the horizontal axis shows the angle of transmission axis of the polarizing plate (in units of degrees (“°”)). The polarization degree of each of the prism sheets according to Comparative Examples 1 and 2 and Example 1 was calculated based on the maximum brightness value and the minimum brightness value obtained from the experiment results shown in FIG. 11. Specifically, when the polarization degree is ρ, the maximum brightness value is Imax, and the minimum brightness value is Imin, the polarization degree can be determined by ρ=(Imax−Imin)/(Imax+Imin). The polarization degree calculation results showed that the polarization degree of Comparative Example 1 was 6%, the polarization degree of Comparative Example 2 was 9.3%, and the polarization degree of Example 1 was 16.5%.

The experiment results for Comparative Experiment 1 will be described. It can be seen from FIG. 11 that, while the prism sheets according to Example 1 and Comparative Example 2 had substantially symmetric brightness distributions, the prism sheet according to Comparative Example 1 had an asymmetric brightness distribution. This is believed due to the fact that, because the base member of the prism sheet according to Comparative Example 1 had been manufactured by biaxial stretching method, the polarization state was susceptible to disturbance when light passed through the base member. Accordingly, in the prism sheet according to Comparative Example 1, when the transmission axis of the polarizing plate was 90° and the amount of transmitted light of the P-polarization component was at a maximum, the brightness value was the lowest, and the polarization degree is also lowest at 6%. In contrast, in the prism sheets according to Example 1 and Comparative Example 2, in which the base member included unstretched film, the polarization state of the transmitted light through the base member was not susceptible to disturbance, so that, when the brightness value when the transmission axis of the polarizing plate was 90° was higher than in Comparative Example 1, and the polarization degree was also higher than in Comparative Example 1. When Example 1 and Comparative Example 2 are compared, the prism sheet 20 according to Example 1 had a relatively high brightness value when the transmission axis of the polarizing plate was 90°, and the polarization degree was also relatively high, compared with the prism sheet according to Comparative Example 2. This is believed due to the fact that in the prism sheet 20 according to Example 1, the P-polarization component included in the output light from the light guide plate 19 can be caused to be emitted toward the polarizing plate with higher utilization efficiency because of the prism portions 42 and 43 (incidence angle control structure AIC) provided on both front and rear sides.

As described above, the backlight unit (lighting device) 12 according to the present embodiment includes: the LED (light source) 17; the light guide plate 19 having a square plate shape and including outer peripheral end surfaces of which one of a pair of end surfaces constituting opposite sides is the light incident surface 19b on which light emitted from the LEDs 17 becomes incident, and the other is the non-light input opposite surface 19d on which the light from the LEDs 17 does not become incident, the light guide plate 19 further including one plate surface providing the light emission surface 19a for emitting light; the prism sheet 20 disposed on the light emission surface 19a side with respect to the light guide plate 19, and including the base member 20a having light transmissivity, the light input-side prism portion 42 formed on light input-side plate surface 20a1 which is the plate surface of the base member 20a on which the light from the light guide plate 19 becomes incident, and including a plurality of light input-side unit prisms 42a disposed side by side and extending in parallel with the light incident surface 19b, and light output-side prism portion 43 formed on the light output-side plate surface 20a2 which is the plate surface of the base member 20a on the opposite side from the light input-side plate surface 20a1 and from which light is emitted, and including a plurality of the light output-side unit prisms 43a disposed and extending in parallel with the light incident surface 19b; and the incidence angle control structure AIC for controlling the light incidence angle φ6 with respect to the first light output-side inclined surface 43a1 disposed on the non-light input opposite surface 19d side with respect to the apex portion in the light output-side unit prisms 43a, the incidence angle control structure AIC being such that the inclination angles θ1, θ2, and θ4 that the first light output-side inclined surface 43a1, the first light input-side inclined surface 42a1 disposed on the light incident surface 19b side with respect to the apex portion in the light input-side unit prisms 42a, and the second light input-side inclined surface 42a2 disposed on the non-light input opposite surface 19d side with respect to the apex portion in the light input-side unit prisms 42a respectively make with respect to the plate surface of the base member 20a are in angle ranges such that the Brewster's angle is included in the light incidence angle φ6 with respect to the first light output-side inclined surface 43a1.

First, the light emitted from the LEDs 17 becomes incident on the light incident surface 19b of the light guide plate 19, and, after propagating in the light guide plate 19, is emitted from the light emission surface 19a. The light emitted from the light emission surface 19a becomes incident on the light input-side unit prisms 42a of the light input-side prism portion 42 disposed on the light input-side plate surface 20a1 of the base member 20a of the prism sheet 20 disposed on the light emission surface 19a side of the light guide plate 19, and is then, after passing through the base member 20a, emitted from the light output-side unit prisms 43a of the light output-side prism portion 43 disposed on the light output-side plate surface 20a2 of the base member 20a.

Specifically, when the output light from the light guide plate 19 becomes incident on the first light input-side inclined surface 42a1 disposed on the light incident surface 19b side with respect to the apex portion in the light input-side unit prisms 42a, the output light is refracted at an angle based on the inclination angle θ1 of the first light input-side inclined surface 42a1. The light that passes through the light input-side unit prisms 42a is totally reflected on the second light input-side inclined surface 42a2 disposed on the non-light input opposite surface 19d side with respect to the apex portion in the light input-side unit prisms 42a, whereby the light travels toward the base member 20a and the light output-side unit prisms 43a while being angled based on the inclination angle θ2 of the second light input-side inclined surface 42a2. The light that has passed through the base member 20a and the light output-side unit prisms 43a, when being emitted from the first light output-side inclined surface 43a1 disposed on the non-light input opposite surface 19d side with respect to the apex portion in the light output-side unit prisms 43a, is refracted at an angle based on the inclination angle θ4 of the first light output-side inclined surface 43a1, whereby the travel direction is angled so as to approach the normal direction to the plate surface of the base member 20a.

The incidence angle control structure AIC is configured such that the inclination angles θ1 and θ2 of the first light input-side inclined surface 42a1 and the second light input-side inclined surface 42a2 of the light input-side unit prisms 42a, and the inclination angle θ4 of the first light output-side inclined surface 43a1 of the light output-side unit prisms 43a are such that the light incidence angle φ6 with respect to the first light output-side inclined surface 43a1 is in an angle range including the Brewster's angle. Accordingly, the light passing through the light output-side unit prisms 43a and travelling toward the first light output-side inclined surface 43a1 has the incidence angle φ6 with respect to the first light output-side inclined surface 43a1 which is in an angle range including the Brewster's angle. Accordingly, with respect to the P-polarization component of the light that travels toward the first light output-side inclined surface 43a1, there is hardly any attenuation by being reflected by the first light output-side inclined surface 43a1, and the light is emitted from the first light output-side inclined surface 43a1 with high efficiency. In addition, the light supplied to the light output-side unit prisms 43a is angled by the first light input-side inclined surface 42a1 and the second light input-side inclined surface 42a2 of the light input-side unit prisms 42a on the basis of their respective inclination angles θ1, θ2, and θ4 in advance. Accordingly, compared with conventional examples, attenuation of P-polarization component can be suppressed appropriately in accordance with the output angle of the output light from the light guide plate 19. In this way, high light utilization efficiency can be achieved.

The incidence angle control structure AIC may also be configured such that the light incidence angle φ6 with respect to the first light output-side inclined surface 43a1 is in an angle range such that the reflectance of the P-polarization component of light on the first light output-side inclined surface 43a1 becomes not more than 1%. In this way, the P-polarization component of light passing through the light output-side unit prisms 43a and travelling toward the first light output-side inclined surface 43a1 is emitted from the first light output-side inclined surface 43a1 with higher efficiency, whereby higher light utilization efficiency can be obtained.

The prism sheet 20 may have a refractive index of 1.585, and the incidence angle control structure AIC is configured such that the light incidence angle φ6 with respect to the first light output-side inclined surface 43a1 is in an angle range of 28° to 34.5°. When the refractive index of the prism sheet 20 is 1.585, the Brewster's angle of the light with respect to the first light output-side inclined surface 43a1 is approximately 32.2°. When, as described above, the incidence angle control structure AIC is configured such that the light incidence angle φ6 with respect to the first light output-side inclined surface 43a1 is in the angle range of 28° to 34.5° including the Brewster's angle, the reflectance of the P-polarization component of light in the first light output-side inclined surface 43a1 becomes not more than 1%, whereby higher light utilization efficiency can be obtained.

The prism sheet 20 may have a refractive index of 1.49, and the incidence angle control structure AIC may be configured such that the light incidence angle φ6 with respect to the first light output-side inclined surface 43a1 is in an angle range of 28° to 37°. When the refractive index of the prism sheet 20 is 1.49, the Brewster's angle of the light with respect to the first light output-side inclined surface 43a1 is approximately 33.9°. When, as described above, the incidence angle control structure AIC is configured such that the light incidence angle φ6 with respect to the first light output-side inclined surface 43a1 is in the angle range of 28° to 37° including the Brewster's angle, the reflectance of the P-polarization component of light in the first light output-side inclined surface 43a1 becomes not more than 1%, whereby higher light utilization efficiency can be obtained.

The light input-side unit prisms 42a is formed such that the inclination angle θ2 of the second light input-side inclined surface 42a2 is relatively smaller than the inclination angle θ1 of the first light input-side inclined surface 42a1, whereas the light output-side unit prisms 43a includes the second light output-side inclined surface 43a2 disposed on the light incident surface 19b side with respect to the apex portion, and is formed such that the inclination angle θ4 of the first light output-side inclined surface 43a1 is relatively smaller than the inclination angle θ5 of the second light output-side inclined surface 43a2. The light propagating in the light guide plate 19, and the light emitted from the light guide plate 19 include a component travelling from the light incident surface 19b side toward the non-light input opposite surface 19d side. In this regard, in the light input-side unit prisms 42a and the light output-side unit prisms 43a, the inclination angles θ2 and θ4 respectively of the second light input-side inclined surface 42a2 and the first light output-side inclined surface 43a1, which are both disposed on the non-light input opposite surface 19d side with respect to the apex portion, are relatively smaller than the inclination angles θ1 and θ5 respectively of the first light input-side inclined surface 42a1 and the second light output-side inclined surface 43a2, which are disposed on the light incident surface 19b side with respect to the apex portion. Accordingly, the extending surface distance of the second light input-side inclined surface 42a2 and the first light output-side inclined surface 43a1 are relatively greater. Accordingly, the light that has been emitted from the light guide plate 19 and that has become incident on the prism sheet 20 can be efficiently angled by the second light input-side inclined surface 42a2 and the first light output-side inclined surface 43a1. In this way, light utilization efficiency can be increased even further.

The light output-side unit prisms 43a is also formed such that the inclination angle θ5 of the second light output-side inclined surface 43a2 is relatively greater than the angle φ9 made by the light totally reflected by the second light input-side inclined surface 42a2 with respect to the plate surface of the base member 20a. The light totally reflected by the second light input-side inclined surface 42a2 of the light input-side unit prisms 42a is angled to have a predetermined angle φ9 with respect to the plate surface of the base member 20a, and travels toward the base member 20a and the light output-side unit prisms 43a. The second light output-side inclined surface 43a2 of the light output-side unit prisms 43a has the inclination angle θ5 relatively greater than the angle φ9 of the light totally reflected by the second light input-side inclined surface 42a2. Accordingly, the light totally reflected by the second light input-side inclined surface 42a2 can be prevented from directly hitting the second light output-side inclined surface 43a2. In this way, the generation of reflected light due to the second light output-side inclined surface 43a2 or transmitted light due to the second light output-side inclined surface 43a2 can be can be avoided. As a result, the output light from the prism sheet 20 is made more uniform, whereby light utilization efficiency can be increased even further.

The prism sheet 20 may have a refractive index in a numerical value range of 1.49 to 1.585, the light input-side unit prisms 42a may be configured such that the inclination angle θ1 of the first light input-side inclined surface 42a1 is in an angle range of 50° to 80° while the inclination angle θ2 of the second light input-side inclined surface 42a2 is in an angle range of 36° to 49°, and the light output-side unit prisms 43a may be configured such that the inclination angle θ4 of the first light output-side inclined surface 43a1 is in an angle range of 46° to 61°. In this way, the light that becomes incident on the first light output-side inclined surface 43a1 is angled in advance by the first light input-side inclined surface 42a1 of the light input-side unit prisms 42a with the inclination angle θ1 in the angle range of 50° to 80°, and by the second light input-side inclined surface 42a2 with the inclination angle θ2 in the angle range of 36° to 49°, whereby the incidence angle φ6 with respect to the first light output-side inclined surface 43a1 with the inclination angle θ4 in the angle range of 46° to 61° is in the angle range of 28° to 37° including the Brewster's angle. In this way, the reflectance of the P-polarization component of light on the first light output-side inclined surface 43a1 becomes not more than 1%, whereby higher light utilization efficiency can be obtained. This is preferable, in particular, when the angle made by the output light from the light guide plate 19 with respect to the normal to the light emission surface 19a is large.

The prism sheet 20 may have a refractive index of 1.585, the light input-side unit prisms 42a may be configured such that the inclination angle θ1 of the first light input-side inclined surface 42a1 is in an angle range of 50° to 80° and the inclination angle θ2 of the second light input-side inclined surface 42a2 is in an angle range of 36° to 48°, whereas the light output-side unit prisms 43a may be configured such that the inclination angle θ4 of the first light output-side inclined surface 43a1 is in an angle range of 50° to 60°. In this way, the light that becomes incident on the first light output-side inclined surface 43a1 is angled in advance by the first light input-side inclined surface 42a1 of the light input-side unit prisms 42a with the inclination angle θ1 in the angle range of 50° to 80° and by the second light input-side inclined surface 42a2 with the inclination angle θ2 in the angle range of 36° to 48°. Accordingly, the incidence angle φ6 with respect to the first light output-side inclined surface 43a1 with the inclination angle θ4 in the angle range of 50° to 60° is in the angle range of 28° to 34.5° including the Brewster's angle (approximately 32.2°). In this way, the reflectance of the P-polarization component of light in the first light output-side inclined surface 43a1 becomes not more than 1%, whereby higher light utilization efficiency can be obtained. This is preferable, in particular, when the angle made by the output light from the light guide plate 19 with respect to the normal to the light emission surface 19a is large.

The prism sheet 20 may have a refractive index of 1.49, and the light input-side unit prisms 42a may be configured such that the inclination angle θ1 of the first light input-side inclined surface 42a1 is in an angle range of 50° to 80° and the inclination angle θ2 of the second light input-side inclined surface 42a2 is in an angle range of 37° to 49°, while the light output-side unit prisms 43a may be configured such that the inclination angle θ4 of the first light output-side inclined surface 43a1 is in an angle range of 46° to 61°. In this way, the light that becomes incident on the first light output-side inclined surface 43a1 is angled in advance by the first light input-side inclined surface 42a1 of the light input-side unit prisms 42a with the inclination angle θ1 in the angle range of 50° to 80° and the second light input-side inclined surface 42a2 with the inclination angle θ2 in the angle range of 37° to 49°. Accordingly, the incidence angle φ6 with respect to the first light output-side inclined surface 43a1 with the inclination angle θ4 in the angle range of 46° to 61° is in the angle range of 28° to 37° including the Brewster's angle (approximately 33.9°). In this way, the reflectance of the P-polarization component of light in the first light output-side inclined surface 43a1 becomes not more than 1%, whereby higher light utilization efficiency can be obtained. This is preferable, in particular, when the angle made by the output light from the light guide plate 19 with respect to the normal to the light emission surface 19a is large.

The light output-side unit prisms 43a may be configured such that the inclination angle θ5 of the second light output-side inclined surface 43a2 is in an angle range of 65° to 80°. The light totally reflected by the second light input-side inclined surface 42a2 of the light input-side unit prisms 42a is angled to have a predetermined angle with respect to the plate surface of the base member 20a, and travels toward the base member 20a and the light output-side unit prisms 43a. The second light output-side inclined surface 43a2 of the light output-side unit prisms 43a has the inclination angle θ5 in the angle range of 65° to 80°. Accordingly, the angle is relatively greater than the angle made by the light totally reflected by the second light input-side inclined surface 42a2 with respect to the plate surface of the base member 20a. Accordingly, the light totally reflected by the second light input-side inclined surface 42a2 can be avoided from directly hitting the second light output-side inclined surface 43a2. In this way, the generation of reflected light due to the second light output-side inclined surface 43a2 or transmitted light due to the second light output-side inclined surface 43a2 can be avoided. As a result, the output light from the prism sheet 20 can be made more uniform, whereby light utilization efficiency can be increased even further.

The light guide plate 19 has the opposing plate surface 19c which is the plate surface on the opposite side from the light emission surface 19a, and on the opposing plate surface 19c, there is formed the output light reflective prism portion 41 including a plurality of the unit reflective prisms 41a disposed side by side and extending in parallel with the light incident surface 19b, wherein the unit reflective prisms 41a include the output light reflective inclined surface 41a1 on the light incident surface 19b side with respect to the apex portion of the prisms, the output light reflective inclined surface 41a1 having the inclination angle θ7 with respect to the opposing plate surface 19c which is smaller than the numerical value obtained by subtracting from 45° the critical angle of the light guide plate 19. Initially, the light emitted from the LEDs 17 and becoming incident on the light incident surface 19b is refracted by the light incident surface 19b so as to have a refractive angle not smaller than the critical angle of the light guide plate 19. Then, the light that has propagated in the light guide plate 19 and been totally reflected by the light emission surface 19a is entirely totally reflected by the output light reflective inclined surface 41a1 of the unit reflective prisms 41a of the output light reflective prism portion 41 and does not pass through the output light reflective inclined surface 41a1. In this way, the travel direction of the light that travels toward the light emission surface 19a is made uniform. The light that has been totally reflected by the output light reflective inclined surface 41a1 and that travels toward the light emission surface 19a includes, in addition to the light emitted from the light emission surface 19a as is, the light totally reflected by the light emission surface 19a again. The light that is totally reflected by the light emission surface 19a again is totally reflected by the next and subsequent the output light reflective inclined surfaces 41a1 of the unit reflective prisms 41a, and is eventually emitted from the light emission surface 19a. That is, the output light from the light emission surface 19a includes to no small extent the light that has been totally reflected a plurality of times by the output light reflective inclined surface 41a1, and such light has the incidence angles with respect to the light emission surface 19a aligned close to the critical angle. In this way, the output angle of the output light from the light emission surface 19a is made uniform, whereby the incidence angle of the light travelling from the light guide plate 19 toward the prism sheet 20 and becoming incident on the light input-side unit prisms 42a is made uniform. Thus, the light can be efficiently provided with a light condensing effect by the prism sheet 20.

The base member 20a includes an unstretched film. In this way, compared with when a biaxial stretch film is used for the base member 20a, for example, disturbance in polarization when the light passes through the base member 20a can be avoided. In this way, the P-polarization component of light can be more efficiently caused to be emitted from the first light output-side inclined surface 43a1, whereby higher light utilization efficiency can be obtained.

The liquid crystal display device (display device) 10 according to the present embodiment includes the backlight unit 12 configured as described above and the liquid crystal panel (display panel) 11 that makes a display using the light from the backlight unit 12. According to the liquid crystal display device 10 of such configuration, the output light from the backlight unit has increased utilization efficiency, whereby a high-brightness and high display-quality display can be made.

### Second Embodiment

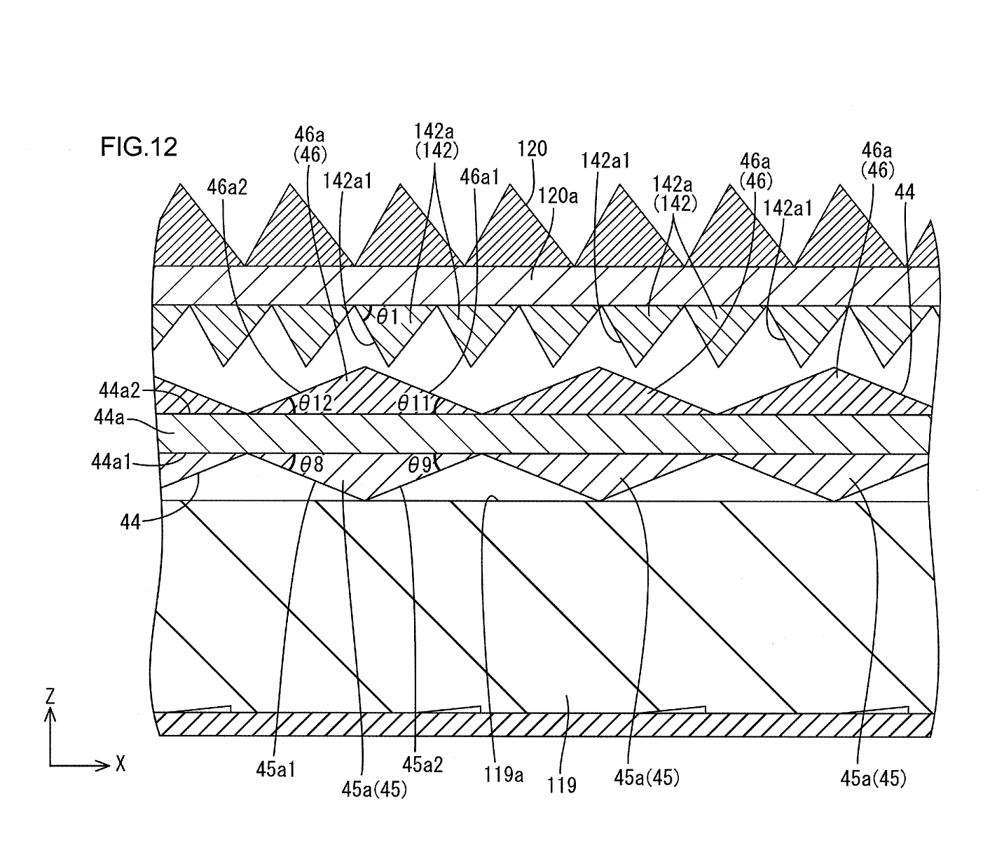

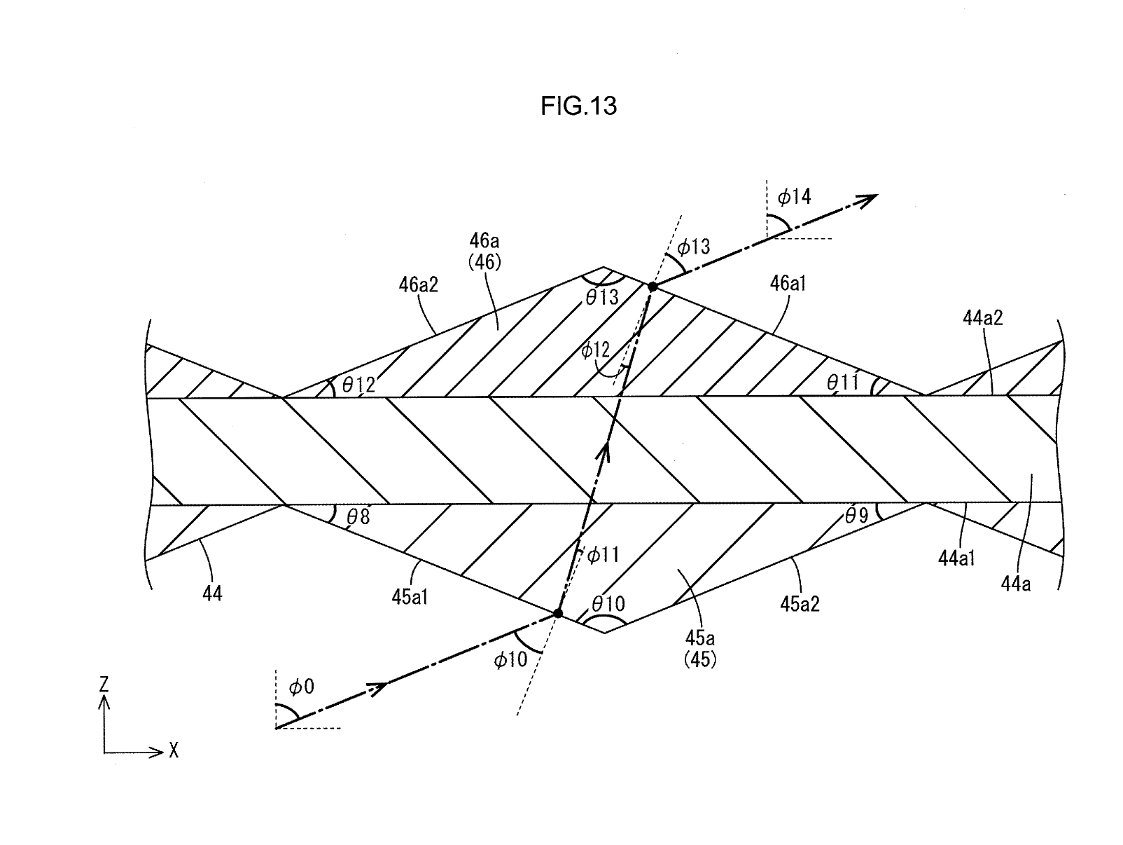

A second embodiment of the present invention will be described with reference to FIG. 12 or FIG. 13. The second embodiment is additionally provided with a polarization control sheet 44. Redundant description of structures, operations, and effects similar to those of the first embodiment is omitted.

According to the present embodiment, as illustrated in FIG. 12, the polarization control sheet 44 is disposed between the light guide plate 119 and the prism sheet 120. The polarization control sheet 44 includes: a film of polarization control sheet base member 44a; a light guide plate-side prism portion 45 formed on a light guide plate-side plate surface 44a1 which is disposed on the light guide plate 119 side of the polarization control sheet base member 44a and on which light from the light guide plate 119 becomes incident; and a prism sheet-side prism portion 46 formed on a prism sheet-side plate surface 44a2 which is disposed on the prism sheet 120 side of the polarization control sheet base member 44a and from which light is emitted toward the prism sheet 120. The polarization control sheet 44 is made of synthetic resin having excellent light transmissivity, such as polymethylmethacrylate (PMMA), polycarbonate (PC), or triacetylcellulose (TAC), and may preferably be made of the same material as that of the prism sheet 120. The polarization control sheet 44 has a refractive index value in a range of 1.49 to 1.585. The polarization control sheet base member 44a includes an unstretched film that has not been stretched during manufacturing process, so that disturbance in polarization can be avoided when light passes through the polarization control sheet base member 44a.

The light guide plate-side prism portion 45, as illustrated in FIG. 12, is integrally provided with the light guide plate-side plate surface 44a1 which is the back-side plate surface of the polarization control sheet base member 44a and on which, being opposed to the light emission surface 119a of the light guide plate 119, the light emitted from the light emission surface 119a becomes incident. The light guide plate-side prism portion 45 includes multiple light guide plate-side unit prisms 45a protruding from the light guide plate-side plate surface 44a1 of the polarization control sheet base member 44a along the Z-axis direction and toward the back side (light guide plate 119 side). The light guide plate-side unit prisms 45a have substantially triangular (substantially mountain-shaped) cross section taken along the X-axis direction and linearly extend along the Y-axis direction, and a number of the light guide plate-side unit prisms 45a are disposed side by side along the X-axis direction on the light guide plate-side plate surface 44a1. That is, the light guide plate-side unit prisms 45a extend in parallel with the light incident surface (not illustrated) of the light guide plate 119, and a number of them are disposed side by side along a direction orthogonal to the extending direction. Each of the light guide plate-side unit prisms 45a, as illustrated in FIG. 13, has a pair of light guide plate-side polarization control inclined surfaces 45a1 and 45a2 across an apex portion. The pair of light guide plate-side polarization control inclined surfaces 45a1 and 45a2 is inclined with respect to the plate surface (light guide plate-side plate surface 44a1; the X-axis direction) of the polarization control sheet base member 44a. Of the pair of light guide plate-side polarization control inclined surfaces 45a1 and 45a2, the one disposed on the light incident surface side (on the left side in FIG. 12 and FIG. 13) with respect to the apex portion is the first light guide plate-side polarization control inclined surface 45a1, and the other one disposed on the non-light input opposite surface side (on the right side in FIG. 12 and FIG. 13), which is not illustrated, with respect to the apex portion is the second light guide plate-side polarization control inclined surface 45a2. The first light guide plate-side polarization control inclined surface 45a1 forms an inclination angle θ8 with respect to the plate surface of the polarization control sheet base member 44a which is the same as a corresponding inclination angle θ9 of the second light guide plate-side polarization control inclined surface 45a2. Specifically, the angles are preferably on the order of 22°. That is, the light guide plate-side unit prisms 45a have an isosceles triangular cross sectional shape. Preferably, the light guide plate-side unit prisms 45a have an apex angle θ10 on the order of 136°. The value obtained by dividing the apex angle θ10 by two (approximately 68°) is equal to the angle made by each of the light guide plate-side polarization control inclined surfaces 45a1 and 45a2 with respect to the normal direction to the plate surface of the polarization control sheet base member 44a, and is smaller than an output angle φ10 (70° to 80°) of the output light from the light guide plate 119. Accordingly, the output light from the light guide plate 119 almost never directly hits the second light guide plate-side polarization control inclined surface 45a2 disposed on the non-light input opposite surface side with respect to the apex portion. The light guide plate-side unit prisms 45a extend along the X-axis direction while the pair of light guide plate-side polarization control inclined surfaces 45a1 and 45a2 maintains the constant inclination angles θ8 and θ9. Accordingly, the inclination angles θ8 and θ9 of the light guide plate-side polarization control inclined surfaces 45a1 and 45a2 do not change at any position with respect to the X-axis direction. The multiple light guide plate-side unit prisms 45a disposed along the X-axis direction have substantially the same inclination angles θ8 and θ9 of the light guide plate-side polarization control inclined surfaces 45a1 and 45a2, apex angle θ10, and bottom-side width dimension and height dimension. The adjacent light guide plate-side unit prisms 45a are also disposed at substantially constant and equal intervals.

The prism sheet-side prism portion 46, as illustrated in FIG. 12, is integrally provided on the prism sheet-side plate surface 44a2, which is the front-side plate surface of the polarization control sheet base member 44a and which, being opposed to the prism sheet 120, causes light to be emitted toward a light input-side prism portion 142 of the prism sheet 120. The prism sheet-side prism portion 46 includes multiple prism sheet-side unit prisms 46a protruding from the prism sheet-side plate surface 44a2 of the polarization control sheet base member 44a along the Z-axis direction toward the front side (prism sheet 120 side). The prism sheet-side unit prisms 46a have a substantially triangular (substantially mountain-shaped) cross section taken along the X-axis direction and linearly extend along the Y-axis direction, and a number of them are disposed on the prism sheet-side plate surface 44a2 side by side along the X-axis direction. That is, the prism sheet-side unit prisms 46a extend in parallel with the light incident surface (not illustrated) of the light guide plate 119, and a number of them are disposed side by side along a direction orthogonal to the extending direction. Each of the prism sheet-side unit prisms 46a, as illustrated in FIG. 13, includes a pair of prism sheet-side polarization control inclined surfaces 46a1 and 46a2 across an apex portion, and each of the pair of prism sheet-side polarization control inclined surfaces 46a1 and 46a2 is inclined with respect to the plate surface of the polarization control sheet base member 44a (prism sheet-side plate surface 44a2; the X-axis direction). Of the pair of prism sheet-side polarization control inclined surfaces 46a1 and 46a2, the one disposed on the non-light input opposite surface side (on the right side in FIG. 13) with respect to the apex portion is the first prism sheet-side polarization control inclined surface 46a1, while the other one disposed on the light incident surface side (on the left side in FIG. 13) with respect to the apex portion is the second prism sheet-side polarization control inclined surface 46a2. The first prism sheet-side polarization control inclined surface 46a1 forms an inclination angle θ11 with respect to the plate surface of the polarization control sheet base member 44a which is the same as a corresponding inclination angle θ12 of the second prism sheet-side polarization control inclined surface 46a2. That is, the prism sheet-side unit prisms 46a have an isosceles triangular cross sectional shape. In addition, the respective inclination angles θ11 and θ12 of the prism sheet-side polarization control inclined surfaces 46a1 and 46a2 have the same values as the respective inclination angles θ8 and θ9 of the light guide plate-side polarization control inclined surfaces 45a1 and 45a2. Specifically, the angles are preferably on the order of 22°. The prism sheet-side unit prisms 46a have an apex angle θ13 which is preferably on the order of 136°. The value obtained by dividing the apex angle θ13 by two (approximately 68°) is equal to the angle made by the respective prism sheet-side polarization control inclined surfaces 46a1 and 46a2 with respect to the normal direction to the plate surface of the polarization control sheet base member 44a, and is smaller than the output angle φ0 (70° to 80°) of the output light from the light guide plate 119. In addition, the inclination angles θ8, θ9, θ11, and θ12 of the four polarization control inclined surfaces 45a1, 45a2, 46a1, and 46a2 are relatively smaller than the inclination angle θ1 made by the first light input-side inclined surface 142a1 of the light input-side unit prisms 142a constituting the light input-side prism portion 142 of the prism sheet 120 with respect to the plate surface of the base member 120a (see FIG. 12). The prism sheet-side unit prisms 46a extend along the X-axis direction while maintaining constant inclination angles θ11 and θ12 of the pair of prism sheet-side polarization control inclined surfaces 46a1 and 46a2. Accordingly, at any position with respect to the X-axis direction, the inclination angles θ11 and θ12 of the prism sheet-side polarization control inclined surfaces 46a1 and 46a2 do not change. The prism sheet-side unit prisms 46a have the same bottom-side width dimension and height dimension respectively as the bottom-side width dimension and height dimension of the light guide plate-side unit prisms 45a. In the multiple prism sheet-side unit prisms 46a disposed side by side along the X-axis direction, the prism sheet-side polarization control inclined surfaces 46a1 and 46a2 have substantially the same inclination angles θ11 and θ12, the same apex angle θ13, and the same bottom-side width dimension and height dimension, and the adjacent prism sheet-side unit prisms 46a are also disposed at substantially constant and equal intervals.

When light is supplied from the light guide plate 119 to the polarization control sheet 44 configured as described above, the following effects are obtained. That is, the output light from the light guide plate 119 (the output light having the output angle φ0) becomes incident on the first light guide plate-side polarization control inclined surface 45a1 of the light guide plate-side unit prisms 45a constituting the light guide plate-side prism portion 45 of the polarization control sheet 44, where the incidence angle is φ10. The light that became incident on the first light guide plate-side polarization control inclined surface 45a1 is refracted at an angle based on the inclination angle θ8 of the first light guide plate-side polarization control inclined surface 45a1, where the refractive angle is φ11. The light that has passed through the light guide plate-side unit prisms 45a passes through the polarization control sheet base member 44a and the prism sheet-side unit prisms 46a, and becomes incident on the first prism sheet-side polarization control inclined surface 46a1, where the incidence angle is φ12. The light that became incident on the first prism sheet-side polarization control inclined surface 46a1 is emitted toward the prism sheet 120 side while being refracted at an angle based on the inclination angle θ11 of the first prism sheet-side polarization control inclined surface 46a1, where the refractive angle is φ13. The angle made by the output light from the first prism sheet-side polarization control inclined surface 46a1 with respect to the normal direction to the plate surface of the polarization control sheet base member 44a is φ14.

The inclination angle θ8 of the first light guide plate-side polarization control inclined surface 45a1 and the inclination angle θ9 of the first prism sheet-side polarization control inclined surface 46a1 are the same. Accordingly, of the angles φ10 to φ14, φ11 and φ12 are the same, and φ10 and φ13 are the same. Accordingly, the output angle φ14 of the output light from the polarization control sheet 44 is the same as the output angle φ0 of the output light from the light guide plate 119. This means that the output light from the polarization control sheet 44 has a brightness angle distribution similar to that of the output light from the light guide plate 119. Accordingly, the same optical effect can be obtained as if the light from the light guide plate 119 is caused to directly enter the prism sheet 120. Thus, the loss of light associated with the interposition of the polarization control sheet 44 is difficult to occur, whereby high light utilization efficiency can be maintained.

The following discusses the technical significance of making the inclination angles θ8, θ9, θ11, and θ12 of the four polarization control inclined surfaces 45a1, 45a2, 46a1, and 46a2 included in the unit prisms 45a and 46a of the polarization control sheet 44 relatively smaller than the inclination angle θ1 made by the first light input-side inclined surface 142a1 of the light input-side unit prisms 142a constituting the light input-side prism portion 142 of the prism sheet 120 with respect to the plate surface of the base member 120a. Generally, the reflectance of S-polarization component of incident light with respect to an inclined surface of a prism tends to increase as the incidence angle increases (see FIG. 8). In this regard, the inclination angles θ8, θ9, θ11, and θ12 are designed as described above, so that, in the light guide plate-side unit prisms 45a and the prism sheet-side unit prisms 46a of the polarization control sheet 44, the incidence angle of light with respect to each pair of the polarization control inclined surfaces 45a1 and 45a2, 46a1 and 46a2 disposed across the respective apex portion becomes relatively larger than the incidence angle of light with respect to the first light input-side inclined surface 142a1 of the light input-side unit prisms 142a in the prism sheet 120. Accordingly, the reflectance of S-polarization component of the incident light with respect to the respective polarization control inclined surfaces 45a1 and 45a2, 46a1 and 46a2 of the light guide plate-side unit prisms 45a and the prism sheet-side unit prisms 46a is greater than the reflectance of S-polarization component of incident light with respect to the first light input-side inclined surface 142a1 of the light input-side unit prisms 142a. Therefore, the S-polarization component can be reflected by the respective polarization control inclined surfaces 45a1 and 45a2, 46a1 and 46a2 with higher efficiency and returned to the light guide plate 119 side. The light that has been returned to the light guide plate 119 side is again reflected, for example, while traveling toward the prism sheet 1 side, whereby some of the light is converted into P-polarization component. In this way, the S-polarization component of the light supplied to the prism sheet 120 can be increased, whereby higher light utilization efficiency can be obtained. When the polarization degree of output light from the prism sheet 120 with the polarization control sheet 44 according to the present embodiment interposed between the prism sheet 120 and the light guide plate 119 was calculated using a technique similar to the one used for Comparative Experiment 1 of the first embodiment, the result was 27.4%. The value is greater than the polarization degree (16.54%) of Example 1 in Comparative Experiment 1 of the first embodiment.

As described above, according to the present embodiment, the polarization control sheet 44 is disposed between the light guide plate 119 and the prism sheet 120 and includes: a polarization control sheet base member 44a having light transmissivity; the light guide plate-side prism portion 45 including a plurality of light guide plate-side unit prisms 45a formed on the light guide plate-side plate surface 44a1, which is the plate surface of the polarization control sheet base member 44a on the light guide plate 119 side and on which light from the light guide plate 119 becomes incident, and extending in parallel with the light incident surface, the light guide plate-side unit prisms 45a being disposed side by side; and the prism sheet-side prism portion 46 including a plurality of the prism sheet-side unit prisms 46a formed on the prism sheet-side plate surface 44a2, which is the plate surface of the polarization control sheet base member 44a on the prism sheet 120 side and from which light is emitted, and extending in parallel with the light incident surface, the prism sheet-side unit prisms 46a being disposed side by side. In the light guide plate-side unit prisms 45a and the prism sheet-side unit prisms 46a, each pair of the polarization control inclined surfaces 45a1 and 45a2, 46a1 and 46a2 disposed across the respective apex portion makes mutually the same inclination angles θ8, θ9, θ11, and θ12 with respect to the plate surface of the polarization control sheet base member 44a, and is formed such that the same inclination angles are even smaller than the inclination angle θ1 made by the first light input-side inclined surface 142a1 of the light input-side unit prisms 142a of the prism sheet 120 with respect to the plate surface of the base member 120a. In this way, the output light from the light guide plate 119 becomes incident on the light guide plate-side unit prisms 45a constituting the light guide plate-side prism portion 45 disposed on the light guide plate-side plate surface 44a1 of the polarization control sheet base member 44a of the polarization control sheet 44, passes through the polarization control sheet base member 44a, and is then emitted from the prism sheet-side unit prisms 46a constituting the prism sheet-side prism portion 46 disposed on the prism sheet-side plate surface 44a2 of the polarization control sheet base member 44a.

Generally, the reflectance of S-polarization component of incident light with respect to an inclined surface of a prism tends to increase as the incidence angle increases. In this regard, the incidence angle φ10 of light with respect to each pair of the polarization control inclined surfaces 45a1 and 45a2, 46a1 and 46a2 disposed across the respective apex portion in the light guide plate-side unit prisms 45a and the prism sheet-side unit prisms 46a of the polarization control sheet 44 is relatively greater than the incidence angle φ1 of the light with respect to the first light input-side inclined surface 42a1 of the light input-side unit prisms 42a of the prism sheet 120. Accordingly, the reflectance of S-polarization component of the incident light with respect to the respective polarization control inclined surfaces 45a1 and 45a2, 46a1 and 46a2 of the light guide plate-side unit prisms 45a and the prism sheet-side unit prisms 46a is greater than the reflectance of S-polarization component of the incident light with respect to the first light input-side inclined surface 42a1 of the light input-side unit prisms 42a. Therefore, the S-polarization component can be reflected by the respective polarization control inclined surfaces 45a1 and 45a2, 46a1 and 46a2 with higher efficiency and returned to the light guide plate 119 side. The light that has been returned to the light guide plate 119 side is again reflected, for example, while travelling toward the prism sheet 120 side, whereby some of the light is converted into P-polarization component. In this way, the S-polarization component of light supplied to the prism sheet 120 can be increased, whereby higher light utilization efficiency can be obtained. In addition, because the inclination angles θ8, θ9, θ11, and θ12 of the polarization control inclined surfaces 45a1 and 45a2, 46a1 and 46a2 of the light guide plate-side unit prisms 45a and the prism sheet-side unit prisms 46a are mutually the same, the output angle of the light emitted from the light guide plate 119 and the output angle of the light emitted from the polarization control sheet 44 become substantially parallel. In this way, the same optical effect can be obtained as if the light from the light guide plate 119 is caused to enter the prism sheet 120 directly. As a result, the loss of light associated with the interposition of the polarization control sheet 44 is difficult to occur, whereby high light utilization efficiency can be maintained.

### Third Embodiment

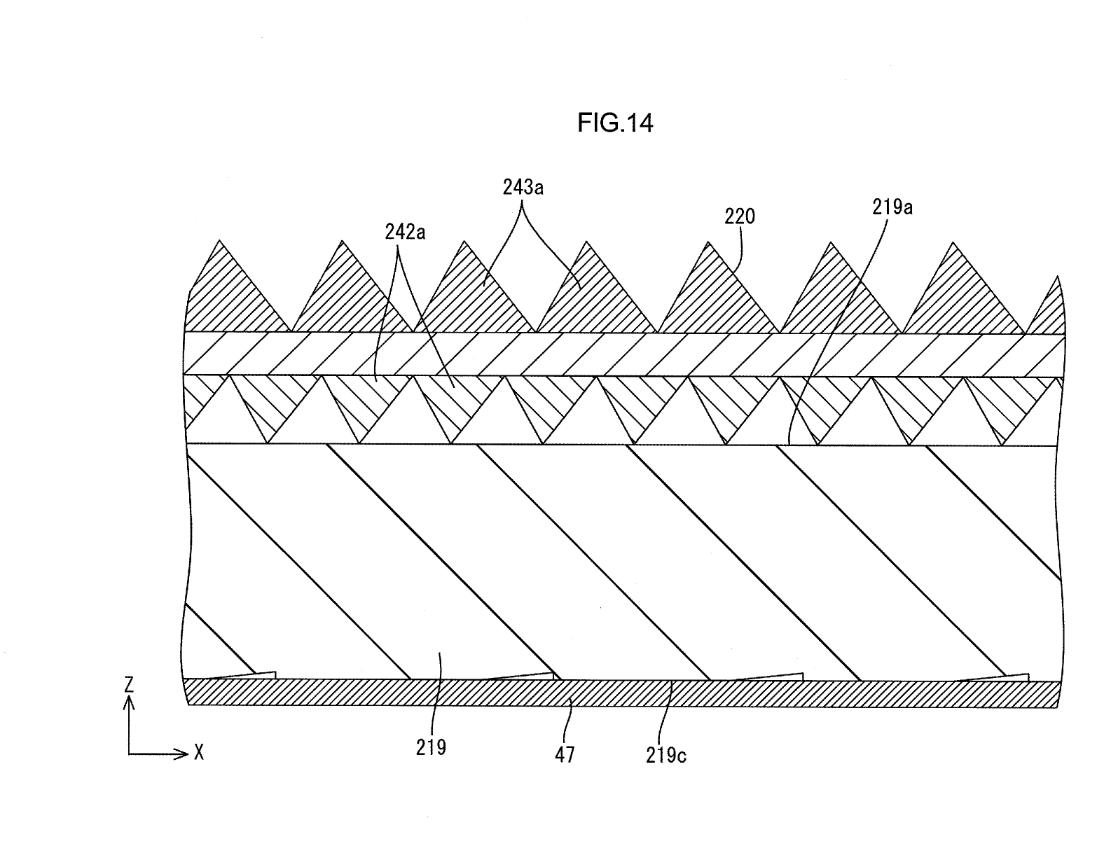

A third embodiment of the present invention will be described with reference to FIG. 14. In the third embodiment, the reflection sheet described in the first embodiment is changed to a diffuser reflection sheet 47. Redundant description of structures, operations, and effects similar to those of the first embodiment is omitted.

On the opposing plate surface 219c side of the light guide plate 219 according to the present embodiment, as illustrated in FIG. 14, a diffuser reflection sheet 47 that diffuses and reflects light is disposed. The diffuser reflection sheet 47 is made of a foamed resin material with white surface. When the light present in the light guide plate 219 includes S-polarization component, the S-polarization component is diffused and reflected by the diffuser reflection sheet 47, whereby some of the S-polarization component is converted into P-polarization component. Accordingly, the S-polarization component that has been returned by the prism sheet 220 to the light guide plate 219 side can be diffused and reflected by the diffuser reflection sheet 47 and thereby converted into P-polarization component, which is again caused to travel toward the prism sheet 220. Thus, the P-polarization component of light supplied to the prism sheet 220 is increased, whereby higher light utilization efficiency can be obtained.

As described above, according to the present embodiment, the plate surface of the light guide plate 219 on the opposite side from the light emission surface 219a is the opposing plate surface 219c, and the diffuser reflection sheet 47 that diffuses and reflects light from the opposing plate surface 219c is disposed in contact with the opposing plate surface 219c. In this way, the S-polarization component of light returned to the light guide plate 219 side by being reflected by the unit prisms 242a and 243a of the prism sheet 220 is diffused and reflected by the diffuser reflection sheet 47, whereby some of the S-polarization component is converted into P-polarization component. In this way, the S-polarization component of light supplied to the prism sheet 220 can be increased, whereby higher light utilization efficiency can be obtained.

### Other Embodiments

The present invention is not limited to the embodiments described in the above description and the drawings, and may also include the following embodiments in the technical scope of the present invention.

(1) In the foregoing embodiments, by way of example, the incidence angle φ6 of light with respect to the first light output-side inclined surface is set such that the reflectance of P-polarization component due to the first light output-side inclined surface becomes not more than 1%. However, the incidence angle φ6 of light with respect to the first light output-side inclined surface may be set such that the reflectance of P-polarization component due to the first light output-side inclined surface has a value other than 1%, such as a value exceeding 1%. In this case, the inclination angles of the inclined surfaces of the unit prisms in the prism sheet may be modified as needed, on the basis of the computational expressions described in the first embodiment.

(2) In the foregoing embodiments, by way of example, the refractive index of the prism sheet is in the numerical value range of 1.49 to 1.585. However, the refractive index of the prism sheet may have a value below 1.49, or a value exceeding value 1.585, and such configurations are also included in the present invention. The refractive index of the prism sheet may also have numerical values in the numerical value range of 1.49 to 1.585 other than 1.49 or 1.585. In such cases, the inclination angles of the inclined surfaces of the unit prisms in the prism sheet may be computed on the basis of the computational expressions described in the first embodiment, and modified as needed so as to correspond to the computed results.

(3) In the foregoing embodiments, by way of example, the output angle φ8 of the output light from the prism sheet is set to be ±3°. However, the output angle φ8 of the output light from the prism sheet may be set so as to have values other than ±3°, such as values exceeding ±3°. With regard to the angle range of the output angle φ8 of the output light from the prism sheet, the absolute value of an upper limit value and the absolute value of a lower limit value may have different values. In such cases, the inclination angles of the inclined surfaces of the unit prisms in the prism sheet may be computed on the basis of the computational expressions described in the first embodiment, and modified as needed so as to correspond to the computed results.

(4) In the foregoing embodiments, by way of example, the output angle φ0 of the output light from the light guide plate is in the angle range of 70° to 80°. However, the output angle φ0 of the output light from the light guide plate may have values below 70° or values exceeding 80°, and such embodiments are also included in the present invention. The output angle φ0 of the output light from the light guide plate may also have numerical values other than 70° or 80° in the numerical value range of 70° to 80°. In such cases, the output angle φ0 of the output light from the light guide plate may be computed on the basis of the computational expressions described in the first embodiment, and modified as needed so as to correspond to the computed results.

(5) In the foregoing embodiments, by way of example, the inclination angle θ1 of the first light input-side inclined surface is in the angle range of 50° to 80°. However, the inclination angle θ1 of the first light input-side inclined surface may have values below 50° or values exceeding 80°, and such configurations are also included in the present invention. The inclination angle θ1 of the first light input-side inclined surface may also have numerical values other than 50° or 80° in the numerical value range of 50° to 80°. In such cases, the inclination angles of the inclined surfaces of the unit prisms in the prism sheet may be computed on the basis of the computational expressions described in the first embodiment, and modified as needed so as to correspond to the computed results.

(6) In the foregoing embodiments, the light output-side unit prisms constituting the light output-side prism portion have the bottom-side width dimension and height dimension which are greater than the bottom-side width dimension and height dimension of the light input-side unit prisms constituting the light input-side prism portion. However, the former and the latter may have the same bottom-side width dimension and height dimension, or the latter may have greater bottom-side width dimension and height dimension than the former, and such configurations are also included in the present invention.

(7) In the foregoing embodiments, the base member of the prism sheet and the prism portions are made from the same material so as to have the same refractive index. However, the base member of the prism sheet and the prism portions may be made from the different material and yet they may have substantially the same refractive index. The base member of the prism sheet and the prism portions may also be made from materials with mutually different refractive indexes.

(8) In the above-described second embodiment, the polarization control sheet base member constituting the polarization control sheet and the prism portions are made from the same material so as to have the same refractive index. However, the polarization control sheet base member constituting the polarization control sheet and the prism portions may be made from different materials and yet they may have substantially the same refractive index. The polarization control sheet base member constituting the polarization control sheet and the prism portions may also be made from materials with mutually different refractive indexes.

(9) In the above-described second embodiment, by way of example, the apex angles θ10 and θ13 of the unit prisms constituting the prism portions in the polarization control sheet are 136°, and the inclination angles θ8, θ9, θ11, and θ12 of the polarization control inclined surfaces are 22°. However, what is required is that the inclination angles θ8, θ9, θ11, and θ12 of the polarization control inclined surfaces be smaller than the inclination angle θ1 of the first light input-side inclined surface of the light input-side unit prisms constituting the light input-side prism portion of the prism sheet. Accordingly, the specific values of the inclination angles θ8, θ9, θ11, and θ12 of the polarization control inclined surfaces may be modified as needed in a range in which the condition is satisfied.

(10) The specific material used for the diffuser reflection sheet described in the third embodiment may be modified as needed.

(11) In the foregoing embodiments, the optical sheet placed on the light guide plate includes a single prism sheet. However, other types of optical sheets (for example, a diffuse sheet or a reflection type polarizing sheet) may be added, or a plurality of prism sheets may be used.

(12) In the foregoing embodiments, a single LED board is disposed along the light incident surface of the light guide plate. However, the present invention may also include a configuration in which two or more LED boards are disposed side by side along the light incident surface of the light guide plate.

(13) In the foregoing embodiments, one end surface on the short sides of the light guide plate is the light incident surface, and the LED board is disposed in an opposed manner with respect to the light incident surface. However, the present invention may also include a configuration in which one end surface on the long sides of the light guide plate is the light incident surface, and in which the LED board is disposed in an opposed manner with respect to the light incident surface. In this case, the extending direction of the unit prisms constituting the prism portions of the prism sheet may be aligned with the long-side direction of the light guide plate, and the direction of arrangement of the unit prisms may be aligned with the short-side direction of the light guide plate.

(14) In the foregoing embodiments, the light guide plate has a rectangular shape by way of example. However, the light guide plate may have a square shape. The shape of the light guide plate need not be a perfect square, and may have a shape such that a part of the outer peripheral ends thereof is cut out.

(15) In the foregoing embodiments, top-emitting LEDs are used. However, the present invention may also be applied to an side-emitting LED configuration in which the light emitting surface is provided by side surfaces which are adjacent with respect to the mounting surface with respect to the LED board.

(16) In the foregoing embodiments, by way of example, the touch panel pattern of the touch panel is of projection capacitance type. However, the present invention may also be applied to configurations in which a touch panel pattern of other types are adopted, such as a surface capacitance type, a resistive film type, or an electromagnetic induction type.

(17) Instead of the touch panel described in the above-described embodiments, a parallax barrier panel (switching liquid crystal panel) including a parallax barrier pattern may be used, whereby an image displayed on the display surface of the liquid crystal panel can be separated by a parallax so that the observer can observe the image as a stereoscopic image (3D image, three-dimensional image). The parallax barrier panel and the touch panel may be used in combination.

(18) The parallax barrier panel described in (17) may have a touch panel pattern formed therein so that the parallax barrier panel can also provide a touch panel function.

(19) Besides the above-described embodiments, the specific screen size of the liquid crystal panel may be modified as needed.

(20) In the foregoing embodiments, by way of example, the color sections of the color filter of the liquid crystal panel have the three colors of R, G, and B. However, the color sections may have four or more colors.

(21) In the foregoing embodiments, LEDs are used as the light source. However, other light sources, such as organic EL, may be used.

(22) In the foregoing embodiments, the frame is made of metal. However, the frame may be made of synthetic resin.

(23) In the foregoing embodiments, strengthened glass subjected to chemical strengthening process is used for the cover panel. However, it goes without saying that strengthened glass subjected to air quenching tempering process (physical strengthening process) may also be used.

(24) In the foregoing embodiments, strengthened glass is used for the cover panel. However, it goes without saying that glass which is not strengthened, such as normal glass material (non-strengthened glass) or synthetic resin material, may also be used.

(25) In the foregoing embodiments, a cover panel is used in the liquid crystal display device. However, the cover panel may be omitted. The touch panel may also be omitted.

(26) In the foregoing embodiments, TFTs are used as the switching components for the liquid crystal display device. However, switching components other than TFT (for example, thin-film diode (TFD)) may be used in the liquid crystal display device, which may be configured for monochrome display as well as color display.

### EXPLANATION OF SYMBOLS

10: Liquid crystal display device (Display device)

11: Liquid crystal panel (Display panel)

12: Backlight unit (Lighting device)

17: LED (Light source)

19, 119, 219: Light guide plate

19a, 119a, 219a: Light emission surface

19b: Light incident surface

19c, 219c: Opposing plate surface

19d: Non-light input opposite surface

20, 120, 220: Prism sheet

20a: Base member

20a1: Light input-side plate surface

20a2: Light output-side plate surface

41: Output light reflective prism portion

41a: Unit reflective prism

41a1: Output light reflective inclined surface

42, 142: Light input-side prism portion

42a, 142a, 242a: Light input-side unit prism

42a1, 142a1: First light input-side inclined surface

42a2: Second light input-side inclined surface

43: Light output-side prism portion

43a, 243a: Light output-side unit prism

43a1: First light output-side inclined surface

43a2: Second light output-side inclined surface

44: Polarization control sheet

44a: Polarization control sheet base member

44a1: Light guide plate-side plate surface

44a2: Prism sheet-side plate surface

45: Light guide plate-side prism portion

45a: Light guide plate-side unit prism

45a1: First light guide plate-side polarization control inclined surface

45a2: Second light guide plate-side polarization control inclined surface

46: Prism sheet-side prism portion

46a: Prism sheet-side unit prism

46a1: First prism sheet-side polarization control inclined surface

46a2: Second prism sheet-side polarization control inclined surface

47: Diffuser reflection sheet

AIC: Incidence angle control structure

θ1: Inclination angle

θ2: Inclination angle

θ4: Inclination angle

θ5: Inclination angle

θ7: Inclination angle

φ6: Incidence angle

1. A lighting device comprising:
a light source;
a light guide plate having a square plate shape with outer peripheral end surfaces including a pair of end surfaces constituting opposite sides, one of the pair of end surfaces being a light incident surface on which light emitted from the light source becomes incident, the other of the pair of end surfaces being a non-light input opposite surface on which the light from the light source does not become incident, and one plate surface of the light guide plate being a light emission surface through which light is emitted;
a prism sheet disposed on a light emission surface side with respect to the light guide plate, the prism sheet including
a base member having light transmissivity,
a light input-side prism portion formed on a light input-side plate surface which is a plate surface of the base member on which the light from the light guide plate becomes incident, the light input-side prism portion including a plurality of light input-side unit prisms extending in parallel with the light incident surface and disposed side by side, and
a light output-side prism portion formed on a light output-side plate surface which is a plate surface of the base member on an opposite side from the light input-side plate surface and from which light is emitted, the light output-side prism portion including a plurality of light output-side unit prisms extending in parallel with the light incident surface and disposed side by side; and
an incidence angle control structure for controlling an incidence angle of light with respect to a first light output-side inclined surface disposed on the non-light input opposite surface side with respect to an apex portion in each of the light output-side unit prisms, the incidence angle control structure causing the first light output-side inclined surface, a first light input-side inclined surface disposed on the light incident surface side with respect to the apex portion in each of the light input-side unit prisms, and a second light input-side inclined surface disposed on the non-light input opposite surface side with respect to the apex portion in each of the light input-side unit prisms to make inclination angles with respect to the plate surface of the base member, the inclination angles having magnitudes such that a light incidence angle with respect to the first light output-side inclined surface is in an angle range including the Brewster's angle.

2. The lighting device according to claim 1, wherein the incidence angle control structure is configured such that the light incidence angle with respect to the first light output-side inclined surface is in an angle range in which a reflectance of a P-polarization component of light on the first light output-side inclined surface becomes not more than 1%.

3. The lighting device according to claim 1, wherein
the prism sheet has a refractive index of 1.585, and
the incidence angle control structure is configured such that the light incidence angle with respect to the first light output-side inclined surface is in an angle range of 28° to 34.5°.

4. The lighting device according to claim 1, wherein
the prism sheet has a refractive index of 1.49, and
the incidence angle control structure is configured such that the light incidence angle with respect to the first light output-side inclined surface is in an angle range of 28° to 37°.

5. The lighting device according to claim 1, wherein
the light input-side unit prisms are formed such that the inclination angle of the second light input-side inclined surface is relatively smaller than the inclination angle of the first light input-side inclined surface, and
the light output-side unit prisms each include a second light output-side inclined surface on the light incident surface side with respect to the apex portion of a corresponding one of the light output-side unit prisms, and are formed such that the inclination angle of the first light output-side inclined surface is relatively smaller than the inclination angle of the second light output-side inclined surface.

6. The lighting device according to claim 5, wherein the light output-side unit prisms are formed such that the inclination angle of the second light output-side inclined surface is relatively greater than the angle made by light totally reflected by the second light input-side inclined surface with respect to the plate surface of the base member.

7. The lighting device according to claim 5, wherein
the prism sheet has a refractive index in a numerical value range of 1.49 to 1.585, and
the light input-side unit prisms have the inclination angle of the first light input-side inclined surface in an angle range of 50° to 80° and the inclination angle of the second light input-side inclined surface in an angle range of 36° to 49°, and the light output-side unit prisms have the inclination angle of the first light output-side inclined surface in an angle range of 46° to 61°.

8. The lighting device according to claim 5, wherein
the prism sheet has a refractive index of 1.585, and
the light input-side unit prisms have the inclination angle of the first light input-side inclined surface in an angle range of 50° to 80° and the inclination angle of the second light input-side inclined surface in an angle range of 36° to 48°, and
the light output-side unit prism has the inclination angle of the first light output-side inclined surface in an angle range of 50° to 60°.

9. The lighting device according to claim 5, wherein
the prism sheet has a refractive index of 1.49, and
the light input-side unit prisms have the inclination angle of the first light input-side inclined surface in an angle range of 50° to 80° and the inclination angle of the second light input-side inclined surface in an angle range of 37° to 49°, and
the light output-side unit prisms have the inclination angle of the first light output-side inclined surface in an angle range of 46° to 61°.

10. The lighting device according to claim 6, wherein the light output-side unit prisms have the inclination angle of the second light output-side inclined surface in an angle range of 65° to 80°.

11. The lighting device according to claim 1, wherein
the light guide plate includes an opposing plate surface on a plate surface thereof on the opposite side from the light emission surface, and includes an output light reflective prism portion on the opposing plate surface, and the output light reflective prism portion includes a plurality of unit reflective prisms extending in parallel with the light incident surface and disposed side by side, and
the unit reflective prisms each include an output light reflective inclined surface on the light incident surface side with respect to an apex portion of a corresponding one of the unit reflective prisms, and the output light reflective inclined surface makes an inclination angle, with respect to the opposing plate surface, having a magnitude smaller than a numerical value obtained by subtracting from 45° a critical angle of the light guide plate.

12. The lighting device according to claim 1, wherein the base member comprises an unstretched film.

13. The lighting device according to claim 1, the lighting device further comprising:
a polarization control sheet disposed between the light guide plate and the prism sheet, the polarization control sheet including
a polarization control sheet base member having light transmissivity,
a light guide plate-side prism portion formed on a light guide plate-side plate surface which is the light guide plate-side plate surface of the polarization control sheet base member and on which light from the light guide plate becomes incident, and the light guide plate-side prism portion including a plurality of light guide plate-side unit prisms extending in parallel with the light incident surface and disposed side by side, and
a prism sheet-side prism portion formed on a prism sheet-side plate surface which is the prism sheet-side plate surface of the polarization control sheet base member and from which light is emitted, and comprising a plurality of prism sheet-side unit prisms extending in parallel with the light incident surface and disposed side by side,
wherein each of the light guide plate-side unit prisms and the prism sheet-side unit prisms includes a pair of polarization control inclined surfaces disposed across an apex portion of each of the unit prisms and formed such that the polarization control inclined surfaces of the pair make a same inclination angle with respect to the plate surface of the polarization control sheet base member, the same inclination angle being smaller than the inclination angle made by the first light input-side inclined surface of the light input-side unit prisms in the prism sheet with respect to the plate surface of the base member.

14. The lighting device according to claim 1, wherein the light guide plate includes an opposing plate surface on a plate surface on the opposite side from the light emission surface, and
the lighting device further comprising a diffuser reflection sheet disposed in contact with the opposing plate surface and configured to diffuse and reflect light from the opposing plate surface.

15. A display device comprising:
the lighting device according to claim 1; and
a display panel for making a display using light from the lighting device.
